(19) United States
(12) Patent Application Publication
(10) Pub. No.: US 2008/0013090 A1
(43) Pub. Date: Jan. 17, 2008

(54) Measurement method, measurement unit, processing unit, pattern forming method , and device manufacturing method

(75) Inventor: Tsuneyuki Hagiwara, Tokyo (JP)

Correspondence Address: OLIFF & BERRIDGE, PLC, P.O. BOX 320850, ALEXANDRIA, VA, 22320-4850, US

(73) Assignee: NIKON CORPORATION, TOKYO (JP)

(21) Appl. No.: 11/727,530

(22) Filed: Mar. 27, 2007

(30) Foreign Application Priority Data
Mar. 29, 2006 (JP) 2006-090214

(51) Int. Cl. G01B 11/00

(52) U.S. Cl. 356/400

(57) ABSTRACT

A coherence factor σ of an alignment system is set to 1 or more, and positional information of a mark is detected from a photodetection signal that corresponds to the mark intensity image of the mark due to a zero order light and light of an odd order diffraction from the mark. When σ≧1, a beam pair of a zero order light and a light of +1^{st} order diffraction appears without fail with respect to a beam pair of a zero order light and a light of −1^{st} order diffraction that pass through the same two points on the pupil plane and the positional shift of the mark image caused by both pairs is canceled out, and by the change in mark step or aberration, the change in mark position shift amount is reduced. Accordingly, the mark can be detected with high precision.

### BACKGROUND OF THE INVENTION

1. Field of the Invention

The present invention relates to measurement methods, measurement units, processing units, pattern forming methods, and device manufacturing methods, and more specifically to a measurement method that uses that uses a detection unit which is equipped with an illumination optical system that irradiates an illumination light on a mark formed on an object, a light converging optical system that converges diffracted light from the mark irradiated by the illumination light, and a photoelectric conversion unit which converts the converged light into electrical signals, a measurement unit that uses the measurement method, a processing unit that is equipped with the measurement unit, a pattern forming method that uses the measurement method, and a device manufacturing method that uses the pattern forming method.

2. Description of the Related Art

In position setting (alignment) of a substrate such as a wafer or the like (hereinafter generally referred to as a wafer) used for device manufacturing in a device processing unit such as an exposure apparatus or the like, a mark for position alignment transferred onto the wafer along with a circuit pattern is observed using an optical alignment system equipped in the exposure apparatus, and the position is measured based on the observation results. Measurement accuracy of the mark position decreases due to various factors. For example, one of the factors that cause the decrease is a mark shift (WIS (Wafer Induced Shift)), which occurs when a mark that is originally supposed to be symmetrical in a CMP process or the like becomes asymmetrical and an amplitude and a phase of a diffracted light from the mark change.

Therefore, technology for improving the measurement accuracy of the mark has been proposed in the past (refer to, for example, the pamphlet of International Publication No. WO98/39689, and Kokai (Japanese Unexamined Patent Application Publication) No. 2001-250766). Requirements for measurement accuracy of the mark position are becoming more stringent due to finer device patterns in recent years, and the aberration that the objective lens of the alignment system has (normally around 100 mλ (λ=633 nm) in the RMS value of the wavefront aberration) has come to be considered as a major cause for the measurement accuracy of the mark position to decrease. However, in general, adjusting the aberration itself of the objective lens is costly and also requires long hours. Further, because it is extremely difficult to reduce the aberration completely to zero, mark measurement has to be performed while anticipating positional shift of the mark due to the aberration.

Further, because the positional shift amount of the mark due to the aberration becomes more apparent by defocus on mark measurement, focusing had to be strictly performed on measurement. Further, step difference amount and/or reflectance differ depending of the mark, and when there is an individual difference, the measurement position of the mark changes even if the aberration amount and the defocus amount is the same.

Recently, a proposal has been made of a device processing unit equipped with an alignment system of a multiple lens type, e.g., four eyes, which performs position measurement of a plurality of marks on the wafer. However, in the case where the mark measurement position shifts greatly due to defocus, it is physically difficult to adjust the wafer surface and perform focusing of each of the four points on the wafer simultaneously with each eye, and simultaneous measurement of four or more of the marks was virtually impractical.

### SUMMARY OF THE INVENTION

According to a first aspect of the present invention, there is provided a first measurement method, the method comprising: a detection process in which a detection unit that has an illumination optical system that irradiates an illumination light on a period mark formed on an object, a light condensing optical system that condenses only a zero order light and light of an odd order diffraction from the period mark irradiated by the illumination light, and a photoelectric conversion unit that converts the light that has been condensed into an electrical signal, and whose ratio of numerical aperture of the illumination optical system to the numerical aperture of the light condensing optical system is set to one or more is used to detect positional information related to a periodic direction of the period mark.

According to this method, the mark is measured in an incoherent state where the ratio of the numerical aperture of the illumination optical system to the numerical aperture of the light condensing optical system is set to one or more, and the mark is also detected based on an electrical signal whose light of an even order diffraction which is the cause of noise component is reduced. Therefore, change in measurement error of the mark position caused by a complex effect of aberration in the light condensing optical system and defocus or a complex effect of the individual difference of the mark and defocus is reduced, and it becomes possible to measure the positional information with high precision.

According to a second aspect of the present invention, there is provided a second measurement method, measurement method, comprising: a detection process in which a detection unit that has an illumination optical system that irradiates an illumination light on a period mark formed on an object, a light condensing optical system that condenses diffracted light from the mark, and a photoelectric conversion unit that converts the light that has been condensed into an electrical signal, and whose ratio of numerical aperture of the illumination optical system to the numerical aperture of the light condensing optical system is set to one or more is used to detect positional information related to a periodic direction of the period mark that includes a first component using a first period as a fundamental frequency and a second component using a second period, which is an even multiple of the first period, as a fundamental frequency.

According to this method, in an incoherent state where the ratio of the numerical aperture of the illumination optical system to the numerical aperture of the light condensing optical system is set to one or more, and a period mark that includes a first component using a first period as the fundamental frequency and a second component using a second period, which is an even multiple of the first period, as the fundamental frequency is measured. Then, the diffracted light from the period mark upon measurement is condensed, and based on a electrical signal, which is the condensed light that has been photoelectrically converted, positional information of the period mark related to the periodic direction is detected. In this case, because the ratio of the period of the two different fundamental frequency components is an even order ratio, a diffracted light is generated whose light of an even order diffraction that becomes the cause of noise component is reduced. Accordingly, change in measurement error of the mark position caused by a complex effect of aberration in the light condensing optical system and defocus or a complex effect of the individual difference of the mark and defocus is reduced, and it becomes possible to measure the positional information with high precision.

According to a third aspect of the present invention, there is provided a third measurement method in which a plurality of detection units that is arranged so that each of a plurality of marks arranged on a plurality of different places on an object are simultaneously measurable is used to detect positional information of the marks, the detection units each having an illumination optical system that irradiates illumination light on a mark formed on the object, a light condensing optical system that condenses diffracted light from the mark; and a photoelectric conversion unit that converts the light that has been condensed into an electrical signal, whereby positional information of the mark is measured at an arbitrary sampling interval using the detection unit, while the focus position of the mark to the light condensing optical system is changed in a predetermined range.

According to this method, positional information of a plurality of marks is measured simultaneously using a plurality of detection units. In this case, because the best focus adjustment of the object will not have to be performed on measurement in each of the detection units and each detection unit uses measurement results of the mark position at a plurality of different focus positions, it becomes possible to improve the measurement accuracy of the positional information of the mark by the averaging effect.

According to a fourth aspect of the present invention, there is provided a first measurement unit that measures positional information of an alignment mark formed on an object subject to processing, using the measurement method according to any one of the first to third measurement method of the present invention.

According to this unit, it becomes possible to measure positional information of the mark on the object with high precision.

According to a fifth aspect of the present invention, there is provided a second measurement unit, comprising: an illumination optical system that irradiates an illumination light on a period mark formed on an object; a light condensing optical system that condenses only zero order light and light of an odd order diffraction from the period mark due to irradiation of the illumination light; a photoelectric conversion unit that converts the condensed light into an electrical signal; and a computation unit that computes positional information related to periodic direction of the period mark based on the electrical signal, whereby ratio of numerical aperture of the illumination optical system to the numerical aperture of the light condensing optical system is set to one or more.

According to this unit, it becomes possible to measure positional information of the period mark with high precision.

According to a sixth aspect of the present invention, there is provided a third measurement unit, comprising: a plurality of detection units that each have an illumination optical system that irradiates an illumination light on a mark formed on an object, a light condensing optical system that condenses diffracted light from the mark, and a photoelectric conversion unit that converts the condensed light into an electrical signal, and is arranged so that each of a plurality of marks arranged on a plurality of different places on the object are simultaneously measurable; and a controller that measures positional information of the plurality of marks at an arbitrary sampling interval using the plurality of detection units, while the position of the object in an optical axis direction of the light condensing optical system is changed in a predetermined range.

According to this unit, the controller uses the plurality of detection units, and simultaneously measures the positional information of the plurality of marks. In this case, because the best focus adjustment of the object will not have to be performed on measurement in each of the detection units and each detection unit uses measurement results of the mark position at a plurality of different focus positions, it becomes possible to improve the measurement accuracy of the positional information of the mark by the averaging effect.

According to a seventh aspect of the present invention, there is provided a processing unit, comprising: a measurement unit according to any one of the first to third measurement unit described above; and a position controller that controls a position of the object, based on measurement results of the measurement unit.

According to this unit, it becomes possible to perform position control (including position setting and position alignment) of the object with high precision.

According to an eighth aspect of the present invention, there is provided a pattern forming method in which a pattern is formed on an object, the method comprising: a measurement process in which positional information of alignment marks formed on the object is measured using the measurement method according to any one of the first to third measurement method of the present invention; and a control process in which a position of the object when the pattern is formed is controlled, based on measurement results of the positional information.

According to this method, it becomes possible to form a pattern on an object with good accuracy.

According to a ninth aspect of the present invention, there is provided a device manufacturing method, comprising: a process in which a pattern is formed on an object using the pattern forming method described above; and a process in which processing is applied to the object on which the pattern is formed.

According to this method, it becomes possible to improve productivity of a device.

### BRIEF DESCRIPTION OF THE DRAWINGS

In the accompanying drawings;

FIG. 1 is a view that shows a schematic configuration of an exposure apparatus related to an embodiment;

FIG. 2A is a planar view that shows a schematic configuration of an alignment system, and FIG. 2B is a view that models positional shift at each focus position in a convex lens that has coma aberration;

FIGS. 3A to 3C are views that show an example of a focus-mark measurement position variation curve (No. 1);

FIGS. 4A and 4B are views that show an example of a focus-mark measurement position variation curve;

FIGS. 5A to 5D are views for describing a pupil plane in the case of σ<1;

FIGS. 6A to 6D are views for describing a pupil plane in the case of σ≧1;

FIG. 7 is a sectional view of a wafer mark related to an embodiment;

FIG. 8 is a view that shows the mark in the form of a complex function;

FIG. 9 is a sectional view of a complex plane of the mark;

FIG. 10 is a view that shows an alternate current component of the mark;

FIG. 11 is a view that shows a direct current component of the mark;

FIG. 12 is a view that shows a complex amplitude AC;

FIG. 13 is a view that shows a complex amplitude B;

FIG. 14 is a view that shows a complex amplitude C;

FIG. 15 is a view that shows a Fourier spectrum of a rectangular wave having a spatial frequency of 1/6P;

FIG. 16 is a view that shows a Fourier spectrum of a rectangular wave having a spatial frequency of 1/P;

FIG. 17 is a spectrum of an amplitude distribution AC;

FIG. 18 is another example of a sectional shape of a wafer mark;

FIG. 19 is typical example of a sectional shape of a wafer mark;

FIG. 20 is a flow chart of a preparatory processing;

FIG. 21A is a view that shows a variation curve of a focus-mark position, FIG. 21B is a view that shows a variation curve of a focus-amplitude position, and FIG. 21C is a view that shows a variation curve of a focus-mark position;

FIG. 22 is a flow chart of an exposure processing;

FIG. 23 is a view that shows a variation curve of a focus-mark position;

FIG. 24 is a view that shows another example of a wafer mark (No. 1);

FIG. 25 is a view that shows another example of a wafer mark (No. 2);

FIG. 26 is a view that shows another example of a wafer mark (No. 3); and

FIG. 27 is a perspective view of a schematic configuration of an alignment system that has a plurality of fields.

### DESCRIPTION OF THE EMBODIMENTS

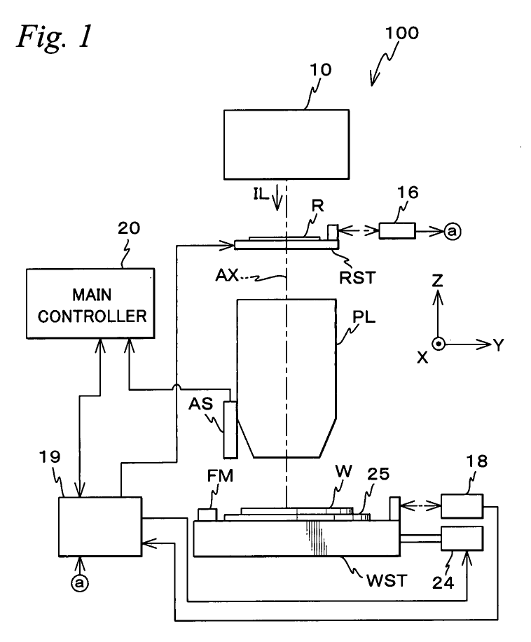

Hereinafter, an embodiment of the present invention will be described, referring to FIGS. 1 to 23. FIG. 1 shows an entire view of an arrangement of an exposure apparatus 100 to which the measurement method related to the embodiment can be suitably applied. Exposure apparatus 100 is a projection exposure apparatus by the step-and-scan method. Exposure apparatus 100, which is shown in FIG. 1, is equipped with an illumination system 10, a reticle stage RST that holds a reticle R, a projection optical system PL, a wafer stage WST that holds a wafer W, an alignment system AS that measures a mark on wafer W, and a control system or the like for such sections.

Illumination system 10 is configured similar to the illumination system disclosed in, for example, Kokai (Japanese Unexamined Patent Application Publication) No. 2001-313250 (corresponding U.S. Patent Application Publication No. 2003/0025890 description) or the like. More specifically, illumination system 10 emits a coherent illumination light for exposure (exposure light) such as a pulsed laser beam towards reticle stage RST.

Reticle stage RST holds reticle R by, for example, vacuum chucking. Reticle stage RST can be driven finely within an XY plane and can be moved in a Y-axis direction at a designated scanning speed. Positional information of reticle stage RST is measured by an interferometer 16. And, based on measurement values of interferometer 16, a stage controller 19 controls the position and speed of reticle stage RST under instructions from a main controller 20.

Projection optical system PL is a both-side telecentric dioptric system that has an optical axis parallel to a Z-axis, which is orthogonal to the XY plane, and has a predetermined projection magnification (e.g., one-quarter times). When exposure light from illumination system 10 illuminates a part of reticle R, a projected image of a circuit pattern or the like corresponding to the illuminated section is projected on wafer W held on wafer stage WST (to be described later), via projection optical system PL.

Wafer stage WST is a stage of six degrees of freedom that is driven freely in an X-axis direction and the Y-axis direction by a stage drive system 24, which includes a linear motor or the like, and can also be driven finely in the Z-axis direction and in rotational directions (a θx direction (a rotational direction around the X-axis), a θy direction (a rotational direction around the Y-axis), and a θz direction (a rotational direction around the Z-axis). On wafer stage WST, wafer W is held via a holder 25 by vacuum chucking or the like. The rotation around each of the axes described above is performed with an optical axis AX of projection optical system PL serving as a reference. That is, by driving wafer stage WST, it becomes possible to move the holding surface of the wafer in directions of six degrees of freedom with optical axis AX as a reference. As wafer stage WST, instead of the stage of six degrees of freedom described above, a configuration can be employed in which wafer stage WST is equipped with a stage of three degrees of freedom that can move freely within the XY plane, and also on the stage, equipped with a stage with three degrees of freedom that is finely movable in directions of three degrees of freedom, in the Z, θx, and θy directions (or a stage that is finely movable in directions of six degrees of freedom).

Positional information of wafer stage WST in directions of six degrees of freedom is measured by an interferometer 18. Based on measurement values of interferometer 18, stage controller 19 controls the position of wafer stage WST. On wafer stage WST, a fiducial mark plate FM is arranged. On fiducial mark plate FM, various reference marks are arranged, which serve as a reference on alignment. In the embodiment, as such reference mark, a mark is employed in which intensity of a diffracted light of an even order besides a zero order light is reduced, and only the zero order light and a diffracted light of an odd order is generated. In the case the intensity of the light of even order diffraction is not reduced, a beat component of an odd order harmonic component and an even order harmonic component will also be included in a spatial frequency component of each order included in the mark intensity image, besides the zero order component and the odd order harmonic component. In such a case, when the intensity of each diffracted light changes even in the slightest terms, the position of the reference mark measured by alignment system AS, which will be described later, will shift due to aberration of the objective lens.

In order to prevent such a shift, in the embodiment, the reference mark is to be a mark that generates only the zero order light and the light of odd order diffraction. Alignment system AS is to measure positional information of the mark using a phase of the spatial frequency component of a plurality of orders included in the mark intensity image, that is, components according to a three-beam interference of a zero order light and positive and negative diffracted lights of the same odd order, so that errors in phase detection of the components due to the influence of aberration are avoided as much as possible even if the ratio of the amplitude of each diffracted light changes. Incidentally, Z position of the reference mark is set substantially the same as the Z position of the surface of wafer W held by holder 25. The specific shape of the reference mark will be described later in the description.

Stage controller 19 controls the position and speed of reticle stage RST and wafer stage WST according to instructions from main controller 20. Stage controller 19 can control both wafer stage WST and reticle stage RST independently, or can make both wafer stage WST and reticle stage RST scan synchronously.

Main controller 20 is a computer that has overall control over the entire apparatus. Besides performing data communication with an upper level unit, main controller 20 controls the various components in exposure apparatus 100 and has overall control of the process performed by exposure apparatus 100.

In the vicinity of the -Y side of projection optical system PL, alignment system AS by the off-axis method is arranged. Alignment system AS performs position measurement of reference marks formed on fiducial mark plate FM and marks used for alignment (wafer marks) formed on wafer W. Alignment system AS photoelectrically detects the spatial intensity image of the wafer mark, and based on the detection results, detects positional information of the wafer mark on an XY coordinate system.

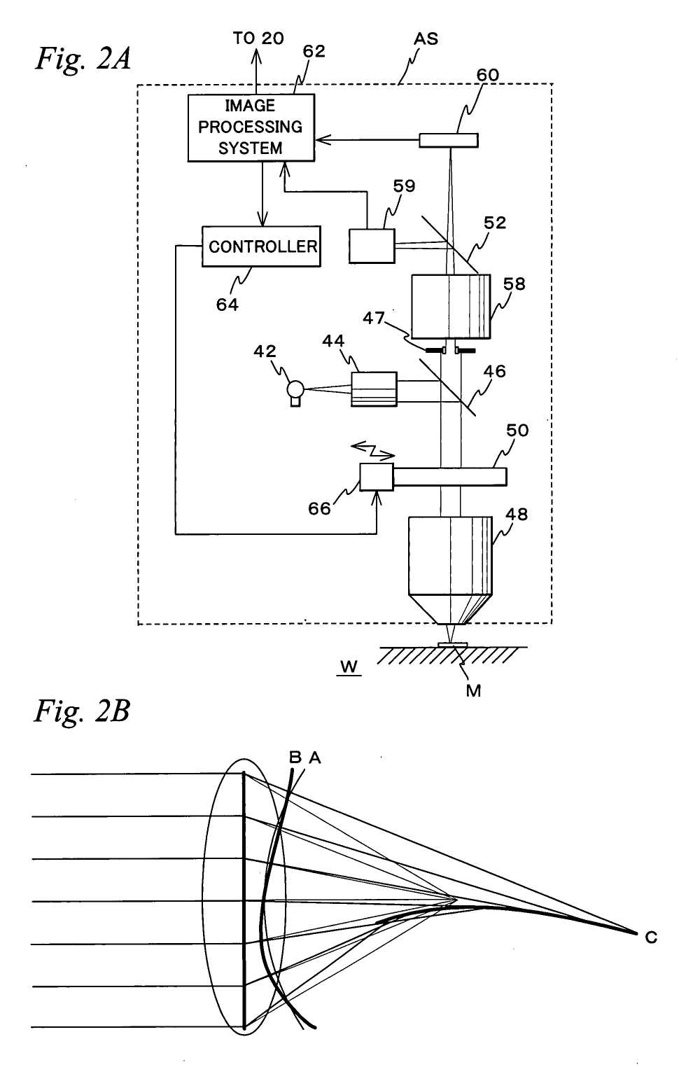

FIG. 2A shows an example of a configuration of alignment system AS. As is shown in FIG. 2A, alignment system AS is equipped with a light source 42, a condenser lens 44, a half mirror 46, an aperture 47, a first objective lens 48, a color filter 50, a half mirror 52, a second objective lens 58, a spectrometer 59, an imaging device 60, an image processing system 62, a controller 64 and the like.

Light source 42 emits light whose wavelength band is a predetermined width and does not expose the photoresist on wafer W. As such light source 42, for example, a halogen lamp can be suitably used. The illumination light emitted from the halogen lamp has a sufficiently wide wavelength band, which prevents the decrease in detection accuracy of the mark due to thin film interference on the resist layer. In the description below, the wavelength band is to be λ₀ nm to λ₁ nm. In this case, λ₀<λ₁, and λ₀ is, for example, 530 nm, and λ₁ is, for example, 900 nm.

The illumination light from light source 42 is converted into a parallel light by condenser lens 44. The parallel light is reflected off half mirror 46, and is condensed in the vicinity of a wafer mark M on wafer W via color filter 50 and the first objective lens 48. More specifically, alignment system AS is equipped with an illumination optical system that performs epi-illumination on wafer mark M, and the illumination optical system is configured by condenser lens 44 and the first objective lens 48.

Reflection light of the illumination light is emitted from wafer mark M. Similar with the mark on fiducial mark plate FM, wafer mark M is a mark that generates only the zero order light and light of odd order diffraction. Details on wafer mark M will be described later in the description. The first objective lens 48 converts each of the diffracted lights from wafer mark M into lights, which are parallel to each other and pass through different positions within a pupil plane (a plane which is in a Fourier transform relation) of the wafer surface. In alignment system AS, the first objective lens 48, aperture 47, and the second objective lens 58 constitute an image-forming optical system (light condensing optical system). Diffracted lights are each made to pass through different positions within a pupil plane of the light condensing optical system. After the diffracted lights pass through color filter 50 and half mirror 46, each of the diffracted lights enters aperture 47. Aperture 47 condenses the beams within the pupil plane of the light condensing optical system. Because aperture 47 limits the numerical aperture of the light condensing optical system, in FIG. 2A, the ratio of the numerical aperture of the illumination optical system to the numerical aperture of the light condensing optical system in alignment system AS, that is, coherence factor σ is one or more (σ≧1). In the embodiment, the configuration is employed in which aperture 47 is to decide (limit) the numerical aperture of the light condensing optical system and coherence factor σ is one or more (σ≧1). However, the present invention is not limited to this. Any configuration can be employed as long as the diameter of the illumination system side is set larger than the diameter of the beams that pass through the pupil plane (the plane corresponding to the Fourier transform plane) of the light condensing optical system. The beams that have passed through aperture 47 are incident on the second objective lens 58. Each of the diffracted lights emitted from the second objective lens 58 is incident on half mirror 52. Each of the diffracted lights reflected off half mirror 52 is incident on spectrometer 59, and each of the diffracted lights that have passed through half mirror 52 is condensed on an imaging plane of imaging device 60, which is at a position conjugate with the surface of wafer W.

Imaging device 60 is, for example, a two-dimensional CCD (Charged Coupled Device). The imaging plane of imaging device 60 is at a position conjugate with the surface of wafer W, and the optical intensity image of wafer mark M is to be formed on the imaging plane. Because the zero order light is also incident on the imaging plane of imaging device 60, the optical intensity image will be the so-called bright-field image to which the zero order light from wafer mark M contributes in image forming.

<Wavelength Selection>

Color filter 50 connects to an actuator 66, and color filter 50 can be inserted/withdrawn from an area centered on the optical axis of the light condensing optical system configured by the first objective lens 48, aperture 47, and the second objective lens 58 of alignment system AS. Accordingly, color filter 50 can shield the light that passes through a predetermined position within the pupil plane of the light condensing optical system. Controller 64 controls the position of actuator 66. Color filter can shield light of any wavelength so that the light does not pass according to the control of controller 64. That is, controller 64 decides the wavelength of the light shielded by color filter 50.

Spectrometer 59 can measure the intensity (that is, spectral reflectivity) of the light per wavelength of the incident light. Because the wavelength band of the diffracted lights is λ₀ nm to λ₁ nm, spectrometer 59 will measure the spectral reflectivity for each wavelength within the wavelength band. The measurement results are sent to image processing system 62.

In the case a mark shift occurs due to chromatic aberration of the light condensing optical system, the spectral reflectivity of the mark can be measured using spectrometer 59 and the chromatic aberration can be corrected according to the spectral characteristics. The chromatic aberration amount is preferably measured according to harmonic order. Measurement of the chromatic aberration is performed using a mark whose spectral reflectivity is known. Such chromatic influence can also be solved according to the following solution. Red (700 to 800 nm), Orange (600 to 710 nm), and Green (530 to 610 nm) color filters can be prepared for a white illumination light having the wavelength of 530 to 800 nm, and by observing both a mark with a thick resist whose mark step is unknown and a FM (fiducial mark) with one of the colors, R, O, and G, TIS does not occur. Incidentally, of the colors R, O, and G, it is preferable to use a color that has the maximum signal amplitude.

Further, by a change or the like in the thickness of the thin film on wafer W due to processing, stability (reproducibility) of the measurement results may change, depending on the wavelength band of the illumination light. In such a case, the optimal wavelength band (=the filter through which maximum signals can be obtained) should be selected. As a matter of course, it goes without saying that it is desirable to perform baseline measurement using the illumination light of the same wavelength band.

Imaging device 60 converts light intensity distribution on the imaging plane that contains information corresponding to the optical intensity image of wafer mark M into electrical signals, and sends the electrical signals to image processing system 62 as imaging signals. Image processing system 62 performs a predetermined image processing on the imaging signals (two-dimensional imaging data). More specifically, first of all, image processing system 62 changes the form of the two-dimensional imaging data into a one-dimensional waveform data regarding the measurement direction of the mark position. Then, at least one of a fundamental frequency component and an odd order harmonic component that corresponds to a fundamental period of the diffraction grating-shaped wafer mark M (that is, at least one of a spatial frequency component of the odd order) is obtained by Fourier transform, and the phase of each spatial frequency component of the odd order is obtained. The phase will be the lateral shift amount from a design position coordinate of wafer mark M regarding the measurement direction on wafer W obtained from the spatial frequency component, that is, the mark measurement position.

The mark measurement position, which can be obtained in the manner described above, is supposed to coincide in an ideal state for all orders. However, the mark measurement position shifts per each order, due to the aberration of the light condensing optical system of alignment system AS. In the case the mark is symmetric, because incoherent imaging is employed in the embodiment, positional shift occurs only due to the influence of an asymmetrical point image (Point spread function (PSF)) at each focus position. That is, the positional shift amount can be predicted if the focus position is obtained. FIG. 2B shows a model of a positional shift amount that occurs at each focus position due to coma. The wavefront that goes through the convex lens shown in FIG. 2B is shaped into a distorted wavefront B, instead of an ideal wavefront A. According to a simulation, since the influence of aberration (coma) to telecentricity resulted in a quadratic “mountain-shaped” curve (indicated as a curve C in FIG. 2B), the focus position can be obtained using such a quadratic function.

In the case asymmetry due to processing is added to the mark waveform, that is, when the so-called process noise is added, the order that has low process noise should be selected. The order that has low process noise can be selected, and the average (or the weighted average) of all the mark measurement positions obtained per each order can be obtained as a final mark position. Of the fundamental frequency component and the odd order harmonic component, any order component can be used for the measurement; however, the most favorable component (for example, a component having only a small number of random components in EGA, or a component that has good reproducibility) can be selected, based on the actual measurement accuracy. For example, if the spatial frequency component of the random noise of the mark base is known, then the use of the data of the spatial frequency component that has a large random noise component in the measurement can be avoided. Normally, because the frequency component that the random noise has is of a low bandwidth in many cases, in most cases the mark position of a harmonic component turns out to be employed.

Further, in the case dispersion of the measurement results differ for each order of the spatial frequency component, data of the spatial frequency component with a small dispersion can be employed. In the case there is not enough signal amplitude and electrical noise (random noise) is noticeable, focus step number is increased. Or, the electrical noise can also be improved by increasing the image accumulation time. Process noise can be minimized according to the selection of order and wavelength. Further, the average value (or the weighted average) of the mark measurement position detected using the spatial frequency component selected in the manner described above can be computed as the final mark position. Image processing system 62 computes a position coordinate of wafer mark M within the imaging field in the manner described above. And, the position coordinate of wafer mark M is sent to main controller 20.

As is described above, in alignment system AS, by adjusting the limit of imaging beams due to aperture 47, it becomes possible to set the ratio of numerical aperture of the light condensing optical system with respect to the numerical aperture of the illumination optical system, or in other words, it becomes possible to set the value of coherence factor σ, optionally in a predetermined range. If σ=∞ is settable, the intensity image of wafer mark M detected in alignment system AS will be an incoherent imaging. In incoherent imaging, point spread function PSF and a convolution of the absolute value squares of the amplitude distribution of wafer mark M are to be the intensity distribution of the intensity image of the mark. In such a state, because interaction (reciprocal action) due to phase distribution of wafer mark M and the aberration of the light condensing optical system of alignment system AS ceases, it becomes possible to perform image recovery, for example, by deconvolution. Further, under incoherent imaging, the influence of aberration of the light condensing optical system of alignment system AS is reduced. For example, when the mark that is to be measured is a step mark made by forming a step in a base, then, in the step mark, step amount, reflectivity, asymmetry and the like differ depending on the mark. However, under incoherent imaging, due to the interaction between the aberration of the light condensing optical system of alignment system AS and the step mark, the mark measurement position for each spatial frequency component hardly changes anymore.

However, it is actually difficult to realize σ=∞, and σ actually has to be set in the range of 0<σ<∞, and the mark measurement will have to be performed under the so-called partial coherent illumination. In the embodiment, even if σ is finite, mark position measurement is achieved substantially in a state equivalent to the incoherent imaging. In the description below, a method for measuring the mark position in a state equivalent to the incoherent imaging will be described concretely.

To be more specific, in the embodiment, mark measurement is performed with the coherent value set to σ≧1. The reason for this will be described below.

First of all, the case will be described when σ<1. In the case σ<1, the intensity distribution of the intensity image of wafer mark M, which corresponds to the imaging signals detected by alignment system AS, will be greatly affected by the quality of the mark (e.g., whether the type of the mark is a contrast mark or a step mark, in the case of a step mark, then the step amount, reflectivity, and asymmetry), and/or the aberration (e.g., coma, spherical aberration and the like) of the light condensing optical system of alignment system AS.

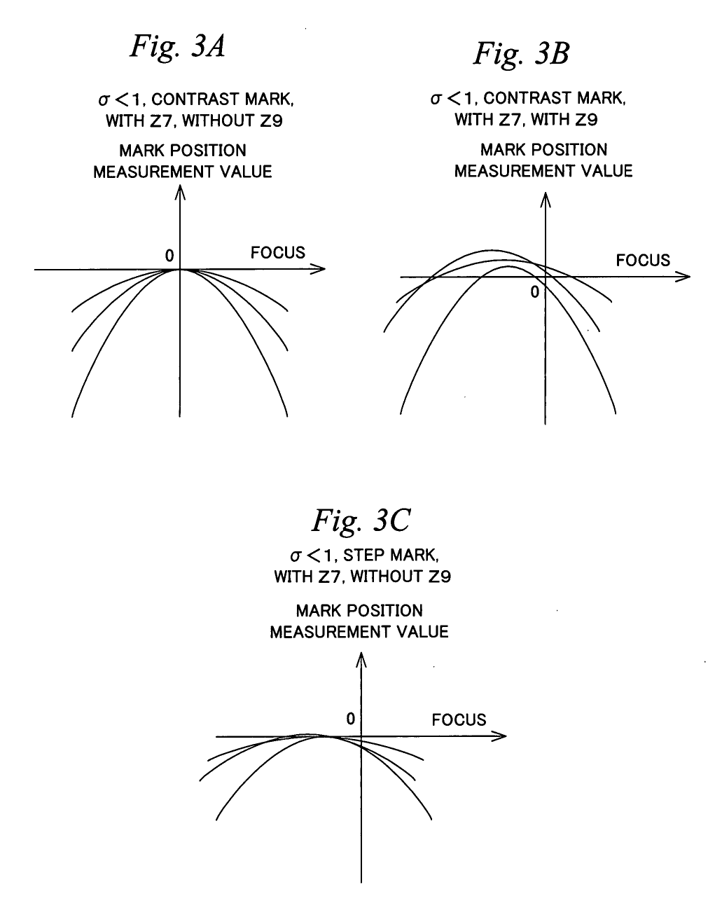

FIG. 3A shows the phase of the spatial frequency component of each odd order included in the intensity distribution of the intensity image of the mark with respect to defocus in the case of σ<1, with coma, and no spherical aberration and when wafer mark M is a contrast mark, that is, shows the state of change of the measurement position of wafer mark M measured for every spatial frequency component for each odd order. FIG. 3A shows variation curves that show the change of the mark position with respect to the focus position in three spatial frequency components of the 1^{st}, 3^{rd}, and 5^{th} order. As is shown in the variation curves in FIG. 3A, the measurement position of wafer mark M changes with respect to focus change in the spatial frequency components of all orders.

Wafer mark M is a mark that generates a zero order light and light of odd order diffraction, and the spatial frequency component of the odd order becomes a component of a three-beam interference of the light of odd order diffraction and the zero order light, and components due to light of even order diffraction will not be included. In this case, the change of the mark position in the spatial frequency component of each order will be a sinusoidal change that moderately curves due to defocus. The variation curve that shows such mark shift will be an even function symmetric to the positive and negative defocus amount. This shows that when the absolute value of the defocus amount is known, the positional shift amount of the mark measurement position due to defocus can be obtained from the variation curve regardless of the positive and negative in the defocus amount.

The variation curve corresponding to the spatial frequency component of each order will be a different variation curve for every order, however all the focus-position variation curves of the spatial frequency components have the extremum at the same focus position. That is, even in the case when σ<1 and the light condensing optical system of alignment system AS has coma, if the mark subject to measurement is a contrast mark and there is no spherical aberration, the best focus position is the same for all the spatial frequency components.

FIG. 3B shows the state of change of the mark measurement position measured from the spatial frequency component of each order, which is included in the intensity image of the mark with respect to defocus, given that σ<1, with coma existing, with spherical aberration, and when wafer mark M is a contrast mark. That is, in this case, the only point that differs from the case in FIG. 3A is the point where spherical aberration exists. Also in FIG. 3B, the variation curve will be a different variation curve for separate orders as in FIG. 3A, however, different from FIG. 3A, the focus position (the best focus position), which is the extremum for each variation curve, also varies per order. In addition, in this case, the variation curve itself of each order changes according to the aberration amount of spherical aberration of alignment system AS, and the mark measurement position and the focus position at the extremum also change. Accordingly, even if the defocus amount is known, since the variation curve itself changes due to the temporal change of the spherical aberration, it is difficult to obtain the positional shift amount of the mark measurement position due to defocus.

FIG. 3C shows the state of change of the mark measurement position measured from the spatial frequency component of each order, which is included in the intensity image of the mark with respect to defocus, given that σ<1, with coma existing, no spherical aberration, and when wafer mark M is a step mark. That is, in this case, the only point that differs from the case in FIG. 3A is the point where a step mark is used as the mark.

Also in the case of FIG. 3C, the measurement position of the mark measured in the spatial frequency component of separate orders will be a different variation curve for each order, and the extremum of each variation curve, or in other words, the best focus position of each order also varies, similar to FIG. 3B. In addition, in this case, the variation curve itself of each order changes according to the depth of the groove of the step mark or the like, and the mark measurement position and the focus position at the extremum also change. Accordingly, even if the defocus amount is known, since the variation curve itself changes due to the depth of the groove of the step mark or the like, it is difficult to obtain the positional shift amount of the mark measurement position due to defocus. Incidentally, the mark itself is a symmetric mark, and the change in the positional shift amount of the mark measurement position generated due to a change in the step difference amount at the top and the bottom of the step, reflectivity, thickness of the resist film and the like while the symmetry of the mark is maintained is called TIS.

The variation curve shown in FIGS. 3A to 3C are cases in which the aberration amount of each of the coma and spherical aberration is extremely large, and in the case the aberration amount is small, then the change amount of the mark measurement position due to defocus becomes small and the variation curves become more like horizontal parallel lines, which makes it difficult to obtain the extremum of the variation curves. In such a case, similar to the mark measurement position, the amplitude of each spatial frequency component changes according to the defocus, and the variation curve will show the same extremum as the extremum of the variation curve of the mark measurement position, therefore, based on the change in the amplitude, it is possible to detect the focus position in which the amplitude becomes maximum.

As is described above, besides coherent illumination (σ=0) and a complete incoherent illumination (σ=∞), that is, when 0<σ<1, mark shift is generated due to the interaction between aberration such as coma, spherical aberration or the like in the light condensing optical system of alignment system AS and the defocus, or due to the interaction between the step of the mark and the defocus.

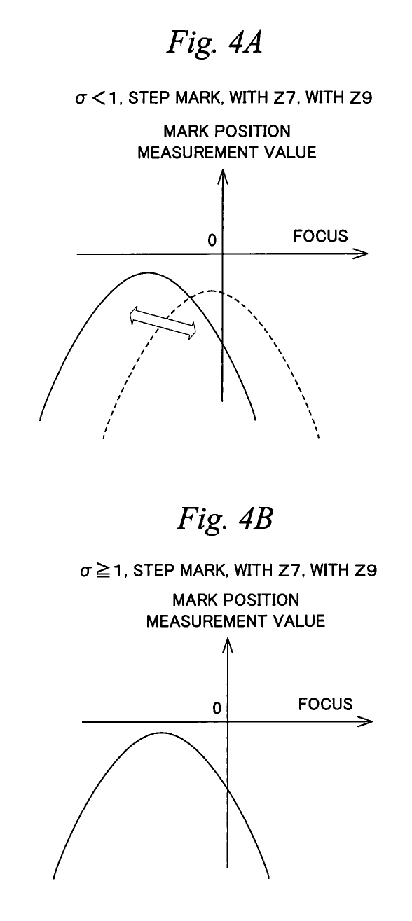

As is shown in FIG. 4A, under the conditions of σ<1, step mark, coma existing, and spherical aberration existing, the focus-mark position variation curve in the spatial frequency component of each order changes according to the aberration amount of spherical aberration and/or the shape of the step mark, however, in the case of σ≧1 as is shown in FIG. 4B, the extremum of each variation curve becomes constant regardless of the aberration amount of spherical aberration and the shape of the step mark. This is because the positional shift of the mark calculated by PSF (the intensity image distribution of the mark) at each focus position is decided. Therefore, in the embodiment, the position of the mark is measured in a state set to σ≧1.

Next, the reason why each variation curve stabilizes in the case when σ≧1 will be described.

In an odd function aberration whose radial function of the Fringe Zernike polynomial is an odd function, such as for example, coma aberration, the phase of the spatial frequency component included in the spatial intensity image of wafer mark M changes accordingly, therefore has a great influence on the mark measurement position. Low order coma is, for example, expressed as Z7 and Z8 in the Fringe Zernike polynomial. Such low order coma changes in an extremely sensitive manner, according to the state of the light condensing optical system. When only Z7 is taken into consideration, pupil function F (ξ, η) is expressed as in the equation below.

Equation 1
F(ξ,η)=Z7(ρ,ψ)=(3ρ³−2ρ)cos ψ (1)

In this case, ρ and φ indicate a pupil coordinate as is shown in the following equation, and Z7 indicates the phase delay of the light on the pupil.

$$Equation 2 \\ ρ = \sqrt{{ξ}^{2} + {η}^{2} ,} ψ = {tan}^{- 1} \frac{η}{ξ} \qquad ( 2 )$$

When the spectrum of the object is expressed as f′ and f″, then cross-modulation coefficient T (f′, f″) can be defined in the equation below.

Equation 3
T(f′,f″)=∫∫σ(ξ,η)F(f′+ξ,η)F*(f″+ξ,η)dξdη (3)

In this case, F (μ, η) is a pupil function as is previously described. Further, F*(f″+ξ, η) is a complex conjugate of pupil function F (f″+ξ, η). Furthermore, σ(ξ, η) is an effective light source. Imaging of the intensity image of wafer mark M will now be considered. In this case, a one-dimensional complex amplitude distribution related to the measurement direction of wafer mark M will be expressed as o(x). The intensity image of wafer mark M by partial coherent illumination can be expressed as in the equation below.

$$Equation 4 \\ \begin{matrix}I ( {x}^{′} ) = {\int }_{- ∞}^{∞} {\int }_{- ∞}^{∞} T ( {f}^{′} , {f}^{″} ) O ( {f}^{′} ) {O}^{*} ( {f}^{″} ) \\ exp ( 2 π ⅈ {x}^{′} ( {f}^{′} - {f}^{″} ) ) ⅆ {f}^{′} ⅆ {f}^{″}\end{matrix} \qquad ( 4 )$$

In this case, O (ξ) indicates the Fourier spectrum of the complex amplitude o(x) of the object. Equation (4) above can be transformed into the following equation using equation (3) above.

$$\begin{matrix}Equation 5 \\ \begin{matrix}I ( {x}^{′} ) = \int \int G ( ξ , η ) \{ {\int }_{- ∞}^{∞} {\int }_{- ∞}^{∞} O ( {f}^{′} ) F ( {f}^{′} + ξ , η ) \\ {O}^{*} ( {f}^{″} ) {F}^{*} ( {f}^{′} + ξ , η ) exp ( 2 π ⅈ {x}^{′} ( {f}^{′} - {f}^{″} ) ) ⅆ {f}^{′} ⅆ {f}^{″} \} \\ ⅆ ξ ⅆ η\end{matrix} & ( 5 )\end{matrix}$$

In this case, supposing wafer mark M is a diffraction grating mark, when only the zero order light and the ±1^{st} order diffracted lights from wafer mark M is taken into consideration and the intensity image by the diffracted lights is to be intensity image I₀₋₁(x′) then I₀₋₁(x′) can be indicated as in the following equation.

$$Equation 6 \\ {I}_{0 - 1} ( {x}^{′} ) = \int \int G ( ξ , η ) \{ \begin{matrix}{c}_{0} F ( 0 + ξ , η ) {c}_{1}^{*} {F}^{*} ( {f}_{1} + ξ , η ) \\ exp ( 2 π ⅈ {x}^{′} ( 0 - {f}_{1} ) ) + \\ {c}_{1} F ( {f}_{1} + ξ , η ) {c}_{0}^{*} {F}^{*} \\ ( 0 + ξ , η ) exp ( 2 π ⅈ {x}^{′} ( {f}_{1} + 0 ) ) + \\ {c}_{0} F ( 0 + ξ , η ) {c}_{- 1}^{*} {F}^{*} \\ ( - {f}_{1} + ξ , η ) exp ( 2 π ⅈ {x}^{′} ( 0 + f ) ) + \\ {c}_{- 1} F ( - {f}_{1} + ξ , η ) {c}_{0}^{*} {F}^{*} \\ ( 0 + ξ , η ) exp ( 2 π ⅈ {x}^{′} ( - {f}_{1} - 0 ) )\end{matrix} \} ⅆ ξ ⅆ η \\ = \int \int G ( ξ , η ) \{ \begin{matrix}2 {c}_{0} {c}_{1}^{*} Re [ F ( 0 + ξ , η ) {c}_{1}^{*} {F}^{*} \\ ( {f}_{1} + ξ , η ) exp ( 2 π ⅈ {x}^{′} ( - {f}_{1} ) ) ] + \\ 2 {c}_{0} {c}_{- 1}^{*} Re [ F ( 0 + ξ , η ) {c}_{1}^{*} {F}^{*} \\ ( - {f}_{1} + ξ , η ) exp ( 2 π ⅈ {x}^{′} ( {f}_{1} ) ) ]\end{matrix} \} ⅆ ξ ⅆ η \qquad ( 6 )$$

In the description above, the phase and the amplitude of the 1^{st} order spatial frequency component (frequency f₁) by the zero order light and the−1^{st} order diffracted light can be expressed as in the following equation (7), and the phase and the amplitude of the 1^{st} order spatial frequency component (frequency f₂) by the zero order light and the +1^{st} order diffracted light can be expressed as in the following equation (8).

Equation 7, Equation 8
Φ_{0,-1}=2c₀c₁*∫∫G(ξ,η)Re└F(0+ξ,η)c₁*F*(f₁+ξ,η)exp(2πix′(−f₁))┘dξdη (7)
Φ_{0,+1}=2c₀c₋₁*∫∫G(ξ,η)Re[F(0+ξ,η)c₁*F*(−f₁+ξ,η)exp(2πix′(f₁))]dξdη (8)

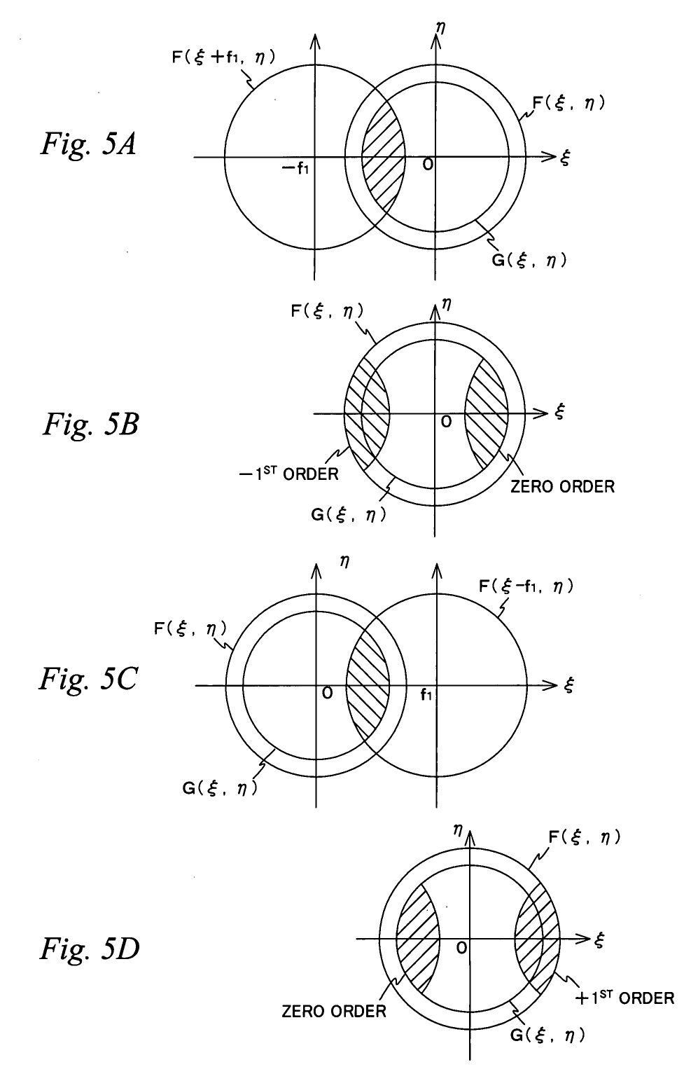

First of all, the case will be described when aperture 47 sets ρ<1. FIG. 5A shows an integral area according to a beam pair of the zero order light and the −1^{st} order diffracted light in the pupil coordinate system of the light condensing optical system in the case σ<1 is set, in diagonal lines. This integral area will be the area that indicates the phase difference between the zero order light and the −1^{st} order diffracted light that become a pair. Equation (7) above indicates that the sinusoidal wave of a frequency (−f₁), which is formed by a two-beam interference according to a phase difference of two points of a beam pair of the zero order light and the −1^{st} order diffracted light whose interval is frequency f₁ on a pupil plane, is averaged in the diagonal section shown in FIG. 5A. In the case the diagonal-lined section shown in FIG. 5A is indicated within the actual pupil plane of the light condensing optical system of alignment system AS, it appears as is shown in FIG. 5B.

Meanwhile, FIG. 5C shows an integral area according to a beam pair of the zero order light and the +1^{st} order diffracted light in the pupil coordinate system in the case σ<1 is set, in diagonal lines. This integral area will be the area that indicates the phase difference between the zero order light and the +1^{st} order diffracted light that become a pair. When the diagonal-lined section of FIG. 5C is indicated within the actual pupil plane of the light condensing optical system of alignment system AS, it appears as is shown in FIG. 5D.

As is can be seen when comparing FIGS. 5B and 5D, on the pupil plane of the light condensing optical. system, two points will appear that form a frequency distance f₁ within the diagonal-lined section, and the beam pair of the zero order light and the −1^{st} order diffracted light and the beam pair of the zero order light and the +1^{st} order diffracted light pass through the two points. In this case, the phase shift influenced by the aberration of the interference fringe due to the two-beam interference between the zero order light and the −1^{st} order diffracted light and the phase shift influenced by the aberration of the interference fringe due to the two-beam interference between the zero order light and the +1^{st} order diffracted light are of the same magnitude but in opposite directions, therefore, the phase shifts are canceled out, and the positional shift amount of the mark image becomes zero.

For example, in the case the phase of the zero order light changes only by α, the sinusoidal wave by the two-beam interference of the zero order light and the −1^{st} order diffracted light shifts only by α/2π. However, the sinusoidal wave by the two-beam interference of the zero order light and the +1^{st} order diffracted light shifts only by −α/2π.

In this case, even when the step of wafer mark M changes and the phase difference of the zero order light and the ±1^{st} diffracted light that pass through two points P1 and P2 that form a distance f₁ in the ξ direction of the pupil also changes, there is a characteristic that no positional shift of the mark occurs.

However, as is can be seen when comparing FIGS. 5B and 5D, the shape of the area (FIG. 5B) where the beam in which the zero order light and the −1^{st} order diffracted light are paired passes within pupil function F (ξ, η) of the light condensing optical system and the shape of the area where the beam in which the zero order light and the +1^{st} order diffracted light are paired passes is not the same shape. This is because the size of the section of effective light source G (ξ, η)≠0 is smaller than the size of the section of pupil function F (ξ, η)≠0. When the shape of the area of the beam pair of the zero order light and the −1^{st} order diffracted light and the shape of the area of the beam pair of the zero order light and the +1^{st} order diffracted light differ in the manner described above, the beam pair of the zero order light and the −1^{st} order diffracted light and the beam pair of the zero order light and the +1^{st} order diffracted light that pass through the two points forming a frequency distance f₁ within the diagonal-lined section do not exist at all the points within the area, and since there are no pairs of the zero order and the +1^{st} order that cancels out the interference fringe of the pair of the zero order and the −1^{st} order generated due to the step change, lateral shift of the interference fringe of the zero order and the −1^{st} order appears. That is, the mark shift changes due to the change in the mark step amount. From the reasons above, in the case σ≧1, the image forming position of the intensity image of the mark will differ according to the mark step amount. That is, TIS occurs.

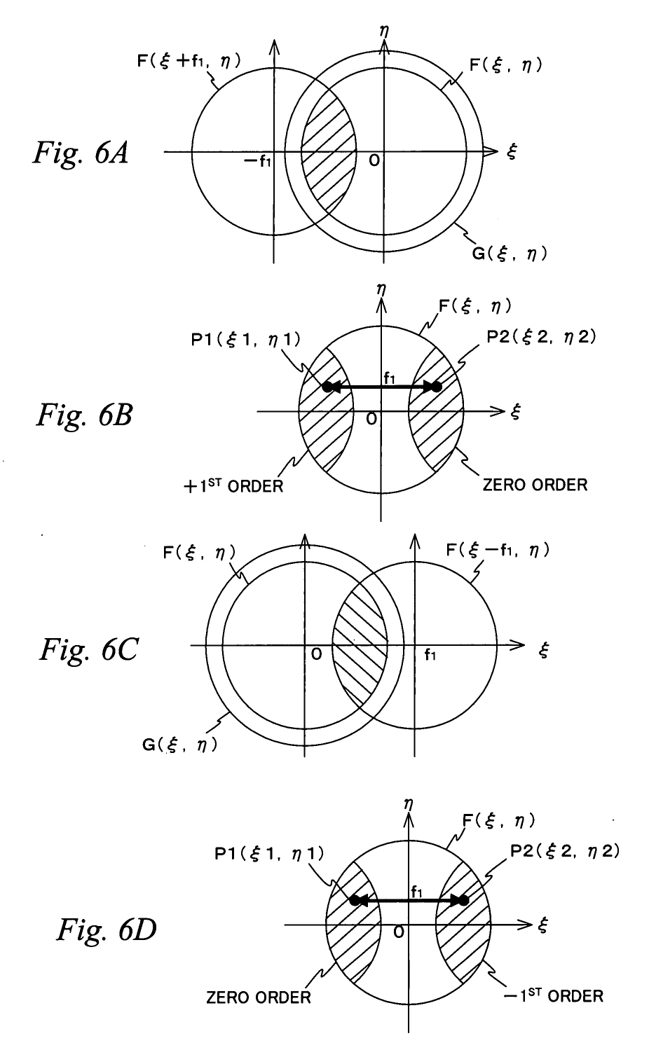

Next, the case will be described when σ≧1 is set. FIG. 6A shows an integral area according to a beam pair of the zero order light and the −1^{st} order diffracted light in the pupil coordinate system in the case σ≧1 is set by aperture 47, in diagonal lines. In the case the diagonal-lined section shown in FIG. 6A is indicated within the actual pupil plane of the light condensing optical system of alignment system AS, it appears as is shown in FIG. 6B.

Meanwhile, FIG. 6C shows an integral area according to a beam pair of the zero order light and the +1^{st} order diffracted light in the pupil coordinate system in the case σ≧1 is set, in diagonal lines. When the diagonal-lined section of FIG. 6C is indicated within the actual pupil plane of the light condensing optical system of alignment system AS, it appears as is shown in FIG. 6D.

However, as is can be seen when comparing FIGS. 6B and 6D, because σ≧1 is set, the size of the section of effective light source G (ξ, η)≠0 is larger than the size of the section of pupil function F (ξ, η)≠0. Accordingly, within pupil function F (ξ, η) of the light condensing optical system, the shape of the area shown in FIG. 6B where the beam in which the zero order light and the −1^{st} order diffracted light are paired passes and the shape of the area shown in FIG. 6D where the beam in which the zero order light and the +1^{st} order diffracted light are paired passes become the same shape. When both areas become the same shape, the beam pair of the zero order light and the −1^{st} order diffracted light and the beam pair of the zero order light and the +1^{st} order diffracted light that pass through the two points forming a frequency distance f₁ within the diagonal-lined section will exist at all the points within the area. Accordingly, the positional shift by the beam pair that passes through the same two points is reciprocally canceled out, thus the positional shift of the mark is canceled out.

The concept described above can be expanded to diffracted light of the m^{th} order (m is an integer that equals 1 or more). That is, if σ≧1, the beam pair of the zero order light and the −m^{th} order diffracted light and the beam pair of the zero order light and the +m^{th} order diffracted light that pass through the same two points within the pupil plane will exist at all two points within the area.

However, in the case wafer mark M includes an infinite harmonic including a light of even order diffraction, σ=∞has to be set in order to achieve an incoherent imaging state to all the spatial frequency components, although it is actually difficult to set σ=∞. Therefore, in the embodiment, as wafer mark M, a mark that generates only an odd number diffracted light will be employed.

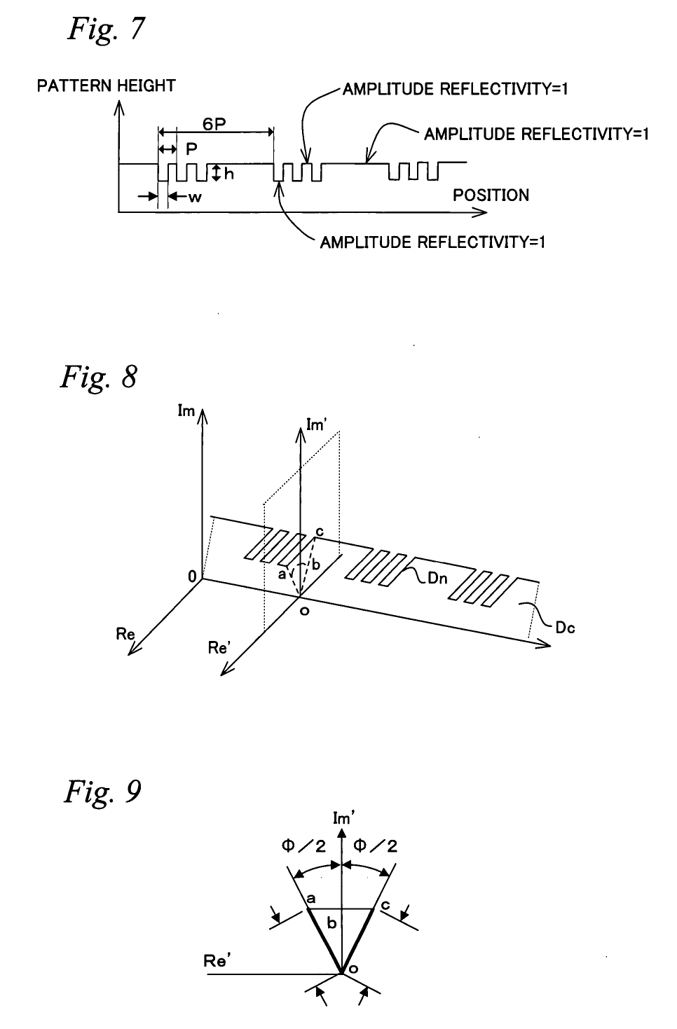

In the embodiment, as the object (mark structure) serving as wafer mark M, a mark of a diffraction grating shape is employed that has a periodic uneven pattern, which is normally called a narrow groove mark whose line width of the groove section is narrow with respect to the pitch. The narrow groove mark is strong to deformation in the CMP process, and because the symmetry of the mark in the measurement direction is maintained, it is advantageous when measuring its position. FIG. 7 shows a sectional view of wafer mark M.

As is shown in FIG. 7, the width of the narrow groove of the mark is expressed as W, the distance between adjacent narrow grooves is P, and the intermittent period is 6P. Each narrow groove width W is set so that it is smaller than P (P>W). Further, as for amplitude distribution, amplitude reflectivity of the section of narrow groove W is to be 1, and amplitude reflectivity of other sections is also 1. Furthermore, the step is expressed as h. Dn in FIG. 8 shows the mark when the mark is indicated in the form of a complex function. In FIG. 8, Re indicates a real number component, and Im indicates an imaginary number component. Now, FIG. 9 shows a sectional view of mark Dn on a Re′-Im′ plane, which is a plane parallel to a Re-Im plane at coordinate 0. The amplitude of sections besides the narrow groove is indicated by a vector oc, and the magnitude is 1. The amplitude of the narrow groove section in indicated by a vector oa, and the magnitude is 1. In the case the depth of the groove is expressed as h and the wavelength of the illumination light is expressed as λ (average wavelength in the case of broadband light), then because the optical path length doubles due to reflection in epi-illumination, an angle Φ formed by vector oc and vector oa can be expressed as 2h/λ*2π=Φ.

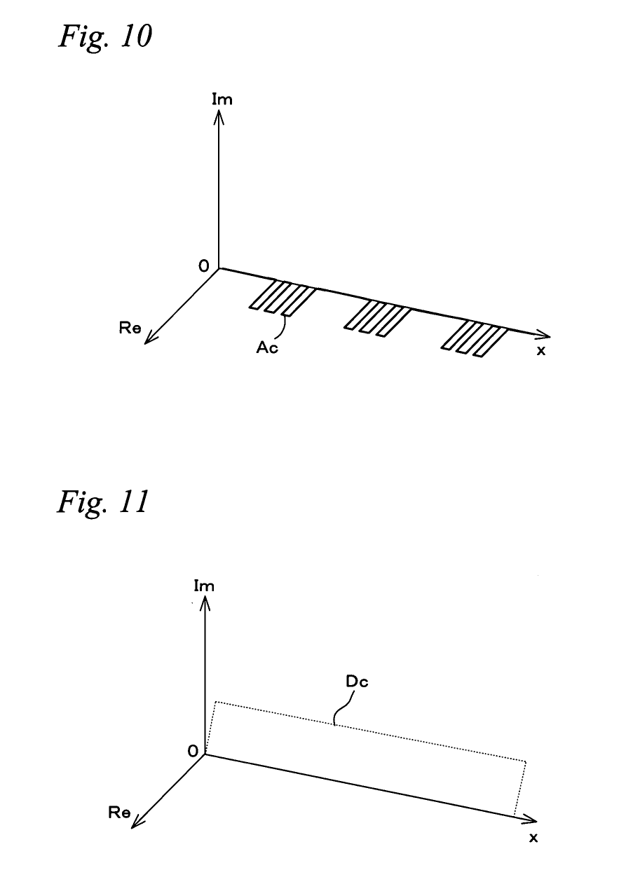

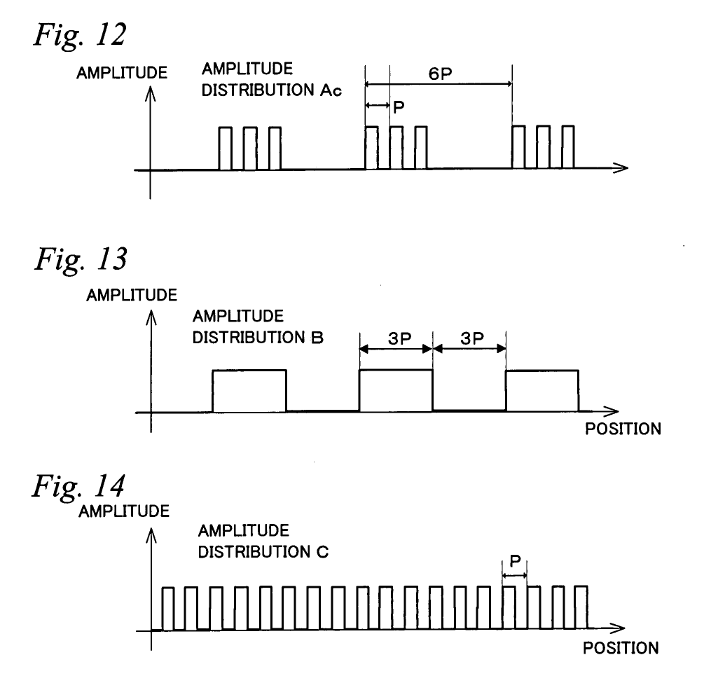

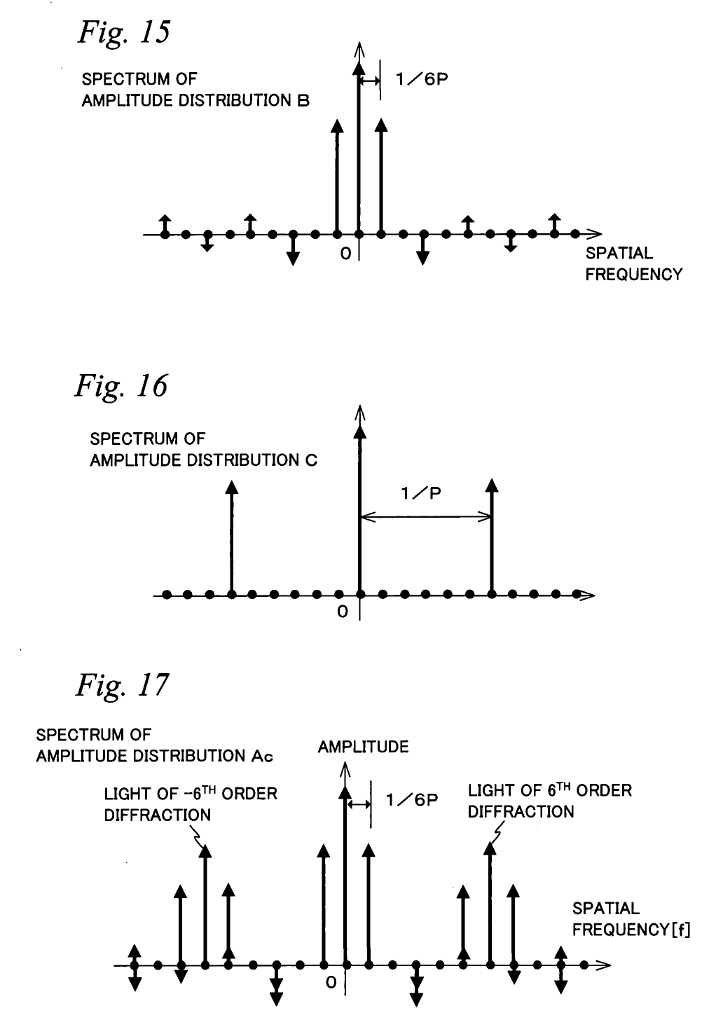

Dn, which is the complex amplitude distribution of the mark, can be considered separated into a direct current component Dc and an alternate current component Ac. Alternate current component Ac in this case, is a component expressed by amplitude parallel to a vector ac in FIG. 9, and is shown in FIG. 10. Direct current component Dc is a component expressed by amplitude parallel. to a vector oc in FIG. 9, and is shown in FIG. 11. In the case of considering the diffracted light generated by complex amplitude distribution Dn, it is effective to consider direct current component Dc and alternate current component Ac separately. Direct current component Dc generates only the zero-order diffracted light. Meanwhile, alternate current component Ac can be viewed as a result of multiplying the periodic amplitude distributions B and C, as is shown in FIGS. 12, 13, and 14. Further, by applying Fourier transform to amplitude distributions B and C, the Fourier spectrum of each of the amplitude distributions B and C is obtained, as is shown in FIGS. 15 and 16. Amplitude distribution B is a well known rectangular wave having a period of 6P, and the spectrum that can be obtained through Fourier transform is only an odd order spectrum other than the zero order component. The odd order spectrum is generated discretely, at ±1/6 P, ±3/6 P, ±5/6 P, ±7/6 P, and so forth.

The Fourier spectrum of amplitude distribution Ac is a convolution of these, and becomes a discrete Fourier spectrum as is shown in FIG. 17A. The diffracted lights generated are only lights of odd order diffraction, in between the −6^{th} order diffracted light and the +6^{th} order diffracted light. And, by satisfying a relation of λ₀/P>(NA+NAi), the lights of even order diffraction of the minimum order, or in other words, the ±6^{th} order diffracted light can prevent the lights from entering the objective lens. Accordingly, only the light of odd order diffraction and the direct current component contribute to the image forming, and it becomes possible to measure the aerial image of the mark without being affected by the light of even order diffraction.

As is shown in FIG. 17, in the spectrum of the amplitude distribution of wafer mark M, a peak appears in spatial frequency 0, ±1/6 P, ±3/6 P, ±5/6 P, and ±6/6 P, however, as for spatial frequency ±2/6 P and ±4/6 P, the spectrum remains at zero. More specifically, in the amplitude distribution of wafer mark M, only the direct current component and only the 1^{st} order component, the 3^{rd} order component, the 5^{th} order component, and the 6^{th} order component among the components under the 6^{th} order are included, and the spatial frequency is zero for the even order smaller than the 6^{th} order, such as the 2^{nd} order and the 4^{th} order.

The intensity of the diffracted light of each order from wafer mark M can be read from the spatial frequency spectrum in FIG. 17. More specifically, other than the zero order diffracted light, the diffracted lights generated from wafer mark M are the 1^{st} order diffracted light, the 3^{rd} order diffracted light, the 5^{th} order diffracted light, and the 6^{th} order diffracted light among the diffracted lights under the ±6^{th} order diffracted light, and the light of even order diffraction smaller than the 6^{th} order, such as the 2^{nd} order and the 4^{th} order are not generated.

Further, in alignment system AS related to the embodiment, numerical aperture (referred to as NAi) of the illumination optical system (condenser lens 44, the first objective lens 48) and numerical aperture (referred to as NA) of the light condensing optical system (the first objective lens 48, the second objective lens 58) is defined according to the expression below.
λ₀/P>(NA+NAi) (9)

In this case, for example, NA=0.5 and NAi=0.5. As is previously described, λ₀ is the shortest wavelength of the illumination light. This limits the diffracted light incident on the light condensing optical system of alignment system AS only to the zero order light and the diffracted lights of the ±1^{st} order, ±3^{rd} order, and the ±5^{th} order corresponding to fundamental frequency P, and the diffracted light of ±6^{th} order corresponding to fundamental frequency P will not enter the first objective lens 48 even if the wavelength is the shortest. Accordingly, the 6^{th} order component in the spatial frequency distribution (spectrum) of wafer mark M actually imaged on the imaging plane of imaging device 60 becomes zero.

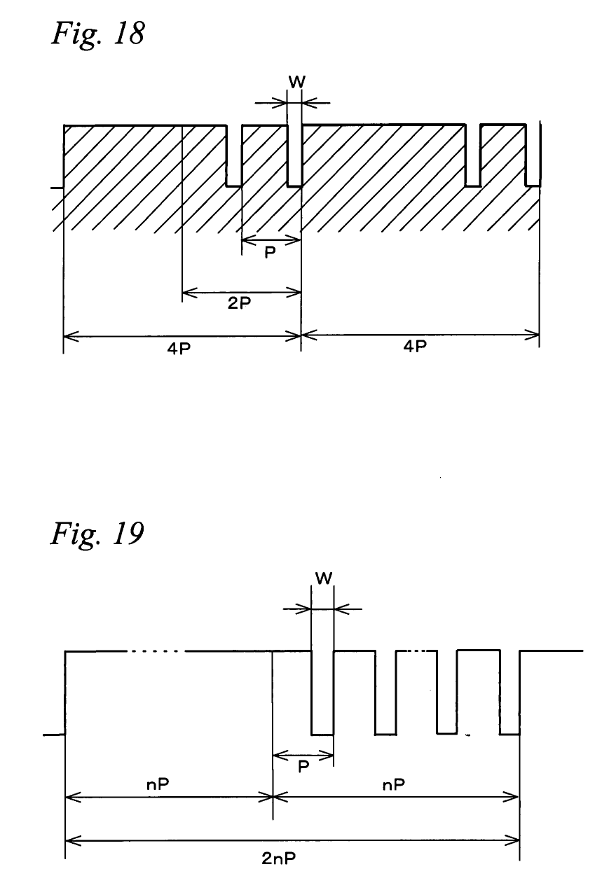

Besides the sectional shape shown in FIG. 7, a sectional shape shown in FIG. 18 can be employed in wafer mark M. In wafer mark M shown in FIG. 18, the point where a set of two narrow grooves is formed at a period of 4P differs from the mark shown in FIG. 7. This mark also has the shape of two rectangular waves with different periods that are synthesized, and the ratio of the period of the two is an even number ratio (1:4). The spatial frequency distribution (spectrum) of this mark is also a convolution of the spatial frequency distribution (frequency) of the two rectangular waves, and in the spectrum, a peak appears in spatial frequency 0, ±1/6 P, ±3/6 P, and ±4/6 P, however, as for spatial frequency ±2/6 P, the spectrum is zero. Further, as is previously described, because of the relation λ₀/P>(NA+NAi), the diffracted light incident on the light condensing optical system of alignment system AS is limited only to the zero order light and the diffracted lights of the ±1^{st} order and the ±3^{rd} order corresponding to fundamental frequency P, and the diffracted light of ±4^{th} order corresponding to fundamental frequency P will not enter the first objective lens 48 even if the wavelength is the shortest. Accordingly, the diffracted light that contributes to forming the image of wafer mark M on the imaging plane of imaging device 60 is limited only to the zero order light and the lights of odd order diffraction.

The sectional shape shown in FIGS. 17 and 18 are generalized to the sectional shape of the wafer mark shown in FIG. 19, and as is shown in FIG. 19, in this sectional shape, a set of n narrow grooves is formed at a period of nP (n is a positive integer). The distance between the adjacent narrow grooves within the set is expressed as P. Width W of each narrow groove is set so that it is smaller than P (P>W). From the shape, the relation of alignment system AS with the numerical aperture of each optical system and the like described above, the diffracted light that contributes to forming the intensity image of wafer mark M on the imaging plane of imaging device 60 is limited only to the zero order light and the lights of odd order diffraction up to the (2n−1)^{th} order. Incidentally, n is decided with random error (the so-called process noise) of the spatial frequency component included in the intensity image of the mark within and between the wafers serving as an evaluation amount.

Wafer mark M generalized in FIG. 19 is a mark that has a periodic structure in which the intensity of light of even order diffraction to the incident light is weakened rather than the intensity of light of odd order diffraction, with respect to alignment system AS.

<Exposure Operation>

Next, the processing operation (exposure operation) of exposure apparatus 100 will be described.

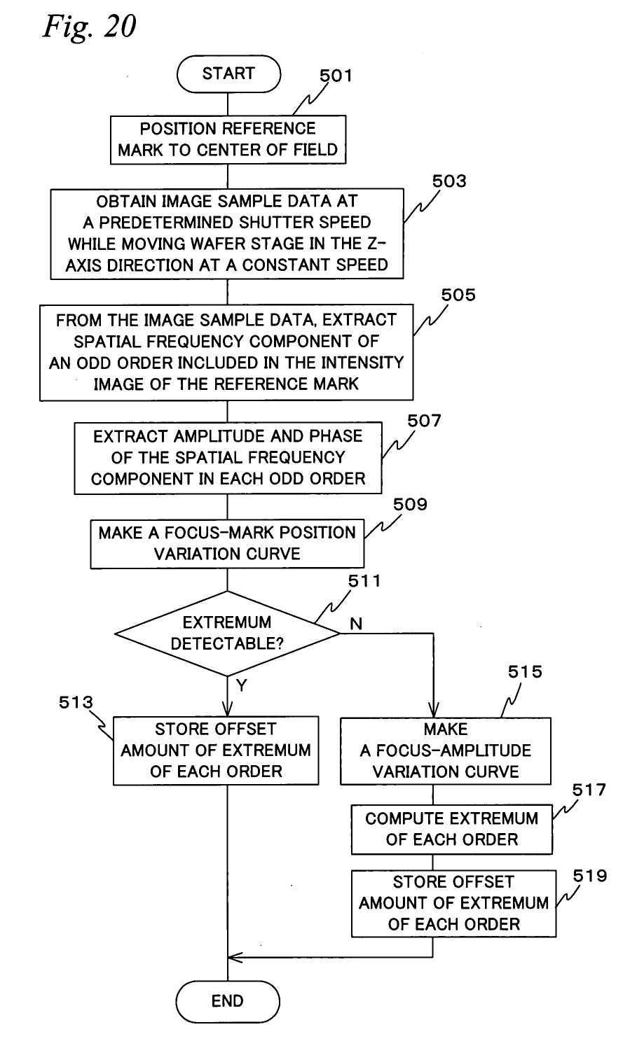

First of all, preparatory processing for mark position measurement in alignment system AS will be described. FIG. 20 shows a flow chart of the preparatory processing. As is shown in FIG. 20, firstly, in step 501, wafer stage WST is driven within the XY plane, and the reference marks on fiducial mark plate FM are made to be positioned in the center of a detection field of alignment system AS. At this step, adjustment can be made by color filter 50 to increase the intensity of the zero order light from the reference mark. In the next step, step 503, alignment system AS obtains an image sample data that includes the intensity image of the reference mark in the detection field at a predetermined shutter speed, while moving wafer stage WST in the Z-axis direction at a low speed by a predetermined distance (e.g., 10 μm). Accordingly, the image sample data is obtained at a plurality of different Z positions. Incidentally, even in the case the light condensing optical system has an aberration such as coma Z7=50 mλ and spherical aberration Z9=50 mλ, because there is only one extremum within the focus range of ±2 μm, the range of moving wafer stage WST can be ±2 μm. According to a simulation, it is preferable to obtain the image of focus steps of around 13 steps.

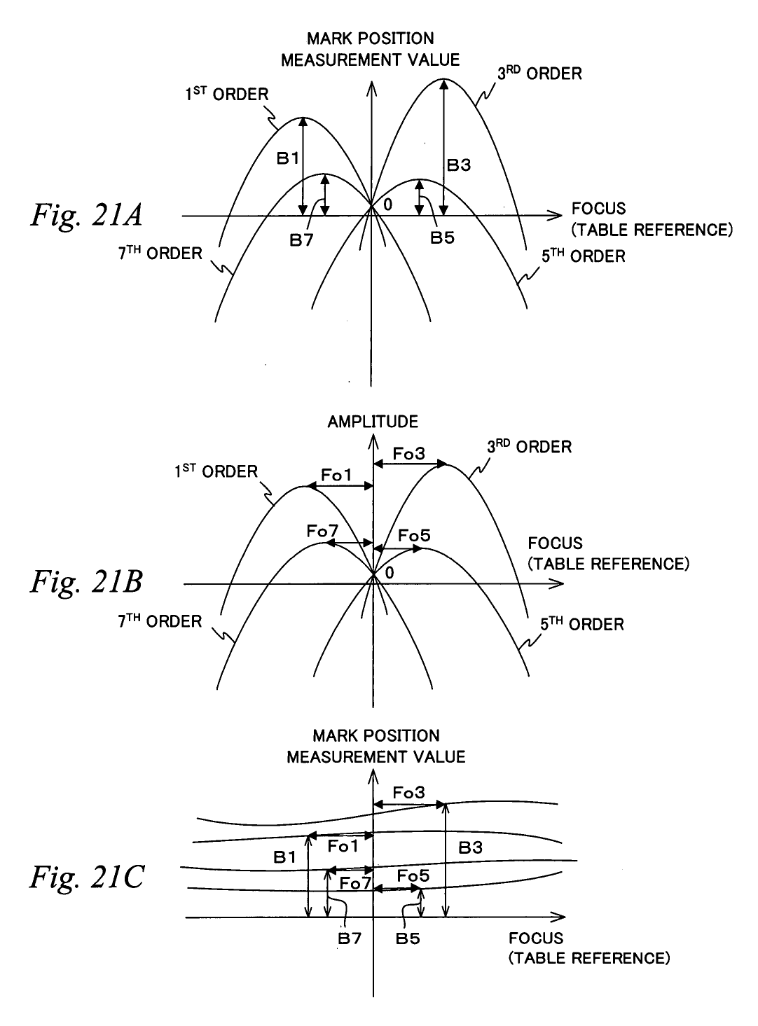

Then, in the next step, step 505, spatial frequency component of the odd order included in the intensity image of the mark is extracted from the image sample data. In the next step, step 507, the amplitude and phase of the spatial frequency component of each odd order are extracted. In the next step, step 509, variation curves of the spatial frequency component of each odd order are made according to function fitting, using, for example, the least squares method or the like. FIG. 21A shows an example of the variation curves of the spatial frequency component of the 1^{st}, the 3^{rd}, the 5^{th}, and the 7^{th} order. In the next step, step 511, the judgment is made of whether or not the extremum can be detected in the variation curves that have been made. For example, in the case variation curves like the ones shown in FIG. 21C are made, because it is difficult to detect the extremum of the variation curves, the judgment here is negative. If the judgment here is affirmative, then the procedure moves to step 513, and if the judgment is negative, the procedure moves to step 515.

In step 513, the offset amount of the variation curves of the focus-mark measurement position corresponding to the spatial frequency component of each order is stored. In the variation curves of the 1^{st}, the 3^{rd}, the 5^{th}, and the 7^{th} order shown in FIG. 21A, B1, B3, B5, and B7 are respectively stored as the offset amounts.

Meanwhile, in step 515, focus-amplitude variation curves are made that shows the relation between amplitude of the spatial frequency component of each odd order and focus, as is shown in FIG. 21B. Then, in the next step, step 517, the focus position, which is the extremum of the focus-amplitude variation curves of the spatial frequency component of each order, is computed. In the variation curves of the 1^{st}, the 3^{rd}, the 5^{th}, and the 7^{th} order shown in FIG. 21B, focus positions Fo1, Fo3, Fo5, and Fo7 are respectively selected.

In the next step, step 519, the offset amount of the extremum of each order is stored. In the variation curves shown in FIG. 21C, offset amounts B1, B3, B5, and 7 at focus positions Fo1, Fo3, Fo5, and Fo7 are shown.

After steps 513 and 519, the processing is completed. From the preparatory processing described above, the offset amount of the mark measurement position at the best focus potion in the spatial frequency component of each order is obtained.

Next, the exposure operation in exposure apparatus 100 is described. Incidentally, reticle R is to be loaded already on reticle stage RST, and predetermined preparatory operations such as reticle alignment, baseline measurement and the like are to be completed.

In exposure apparatus 100, first of all, wafer W subject to exposure is to be loaded on wafer stage WST. Wafer W is a wafer on which a shot area of one layer or more is already formed. In the shot area, search alignment marks and wafer mark M that have the periodical structure described above are arranged.

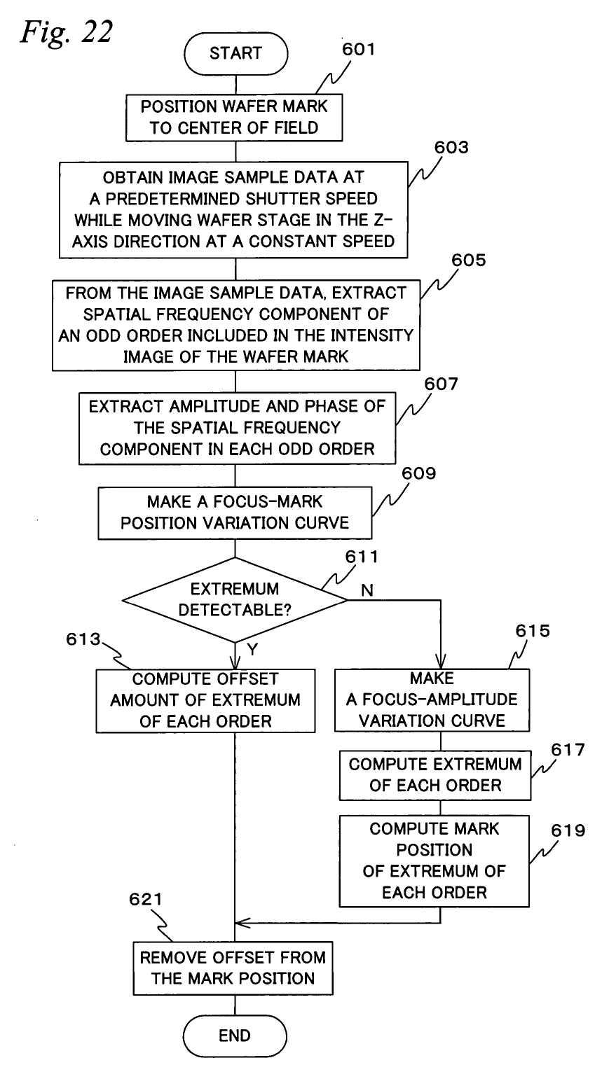

Then, main controller 20 moves wafer stage WST that holds wafer W by suction to a position under alignment system AS, and performs search alignment and wafer alignment via stage controller 19. Details on the processing of the search alignment and fine wafer alignment (e.g., alignment by the EGA method) are disclosed in, for example, Kokai (Japanese Unexamined Patent Application Publication) No. 61-44429 and the corresponding U.S. Pat. No. 4,780,617 and the like. IN this search alignment and wafer alignment, positional information in the XY coordinate system of various alignment marks formed on wafer W is measured, using alignment system AS. For this measurement, main controller 20 sequentially moves wafer stage WST via stage controller 19, so that a plurality of shot areas on which the marks are arranged (sample shots) is positioned under alignment system AS. FIG. 22 shows a flow chart of this mark position measurement processing.

The processing in steps 601 to 611 is the same as the processing in steps 501 to 511. More specifically, wafer mark M is positioned at the center of the detection field of alignment system AS (step 601), wafer stage WST is moved at a constant speed in the Z-axis direction and the image sample data is obtained at a predetermined shutter speed (step 603), the spatial frequency component of each odd order is extracted (step 605), the amplitude and phase are extracted (step 607), the focus-mark position variation curve is made (step 609), and judgment is made whether or not the extremum of the variation curve can be detected (step 611). The light reflected or diffracted at the surface of wafer W including wafer mark M is received at imaging device 60 via the first objective lens 48, the second objective lens 58 and the like. Imaging device 60 converts the intensity image of wafer mark M formed on the image plane into electrical signals, and sequentially outputs the signals to image processing system 62 as image signals (image sample data). In this case as well, the extremum can be easily found by measuring the position of wafer mark M for each order, while adjusting the focus by ±2 μm. Even when taking into consideration the thickness variation and flatness variation of wafer W, the extremum can be captured if the focus is adjusted up to around ±5 μm. If the mark position of wafer W is measured by selecting a filter that has the largest signal amplitude from the R, O, G filters prior to steps 601 to 611 and steps 501 to 511 and obtaining the offset amount of each order accordingly, then measurement can be performed with a higher precision and without being affected by aberration. It becomes possible to use an objective lens that exhibits the same level of performance as a commercial microscope (RMS aberration=50 mλ). In the case the offset is measured once using the O, R, G filters and then the illumination is switched to white, measurement using the white illumination is also possible by controlling the offset.

In the case the judgment in step 611 is affirmed, then the mark position at the extremum of the spatial frequency component of each odd order is computed in step 613. Meanwhile, in the case the judgment in step 611 is denied, the focus-amplitude variation curve is made in step 615, and the extremum of each order is computed in step 617, and then in step 619, the mark position of each order is computed. The processing in steps 611, 613, 615 to 619 is the same as the processing in steps 511, 513, 515 to 519 in FIG. 20.

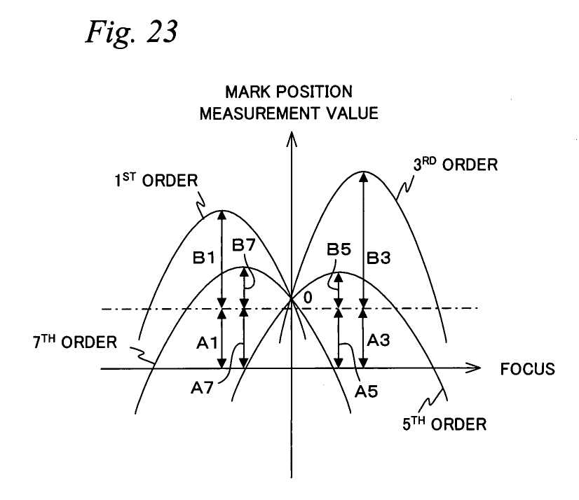

In step 621 after step 613 and step 619, the mark position of the spatial frequency component of each order is obtained by subtracting offset amount B1, B3, B5, and B7 from the mark position obtained from the variation curve of the spatial frequency component of each order. In the variation curve shown in FIG. 23, A1, A3, A5, and A7 are respectively shown as the mark position of each order. The final mark position is computed using these marks in the manner described above.

Mark position information within the imaging field of alignment system AS computed in image processing system 62 is sent to main controller 20. Main controller computes the position coordinate of wafer mark M in the XY coordinate system, based on the mark position information and the positional information of wafer stage WST obtained from interferometer 18 via stage controller 19.

In wafer alignment, main controller 20 statistically computes the arrangement coordinate system on wafer W using the positional information of wafer mark M measured by alignment system AS in the manner described above, as is disclosed in, for example, Kokai (Japanese Unexamined Patent Application Publication) No. 61-44429 and the corresponding U.S. Pat. No. 4,780,617 and the like. Then, based on the arrangement coordinate system, main controller 20 performs exposure by the step-and-scan method on the shot areas. Accordingly, overlay exposure of the shot areas already formed on wafer W is achieved with high precision.

As is described in detail so far, according to the embodiment, because the mark is measured in an incoherent state where the ratio of the numerical aperture of the illumination optical system to the numerical aperture of the light condensing optical system in alignment system AS is set to one or more, and positional information of the mark is also detected based on the intensity image data of the mark whose light of even order diffraction that causes noise component is reduced, change in measurement error of the mark position caused by a complex effect of aberration in the light condensing optical system of alignment system AS and defocus or a complex effect of the individual difference of the mark and defocus is reduced. As a consequence, the measurement accuracy of the position of the mark improves.

That is, according to the embodiment, an incoherent imaging state is achieved under a, which is finite.

Further, according to the embodiment, prior to position measurement of wafer mark M, positional error information (offset amount B1, B3, B5, and B7 obtained from the variation curve of the focus-mark position as is shown in FIG. 21A) related to focus of the reference marks on fiducial mark plate FM to the light condensing optical system of alignment system AS is obtained, and in the position measurement of wafer mark M, the positional error (offset amount B1, B3, B5, and B7) when the measurement was performed is to be reflected in the mark position measurement. In this manner, positional shift of the intensity image of wafer mark M caused by a complex effect of aberration in the light condensing optical system of alignment system AS and defocus or a complex effect of the individual difference of the mark and defocus can be obtained in advance, and on wafer mark measurement, only the positional shift has to be removed, therefore, it becomes possible to measure the positional information of the mark with high precision within a short period of time.

Further, according to the embodiment, in order to obtain the offset amount, the position of the reference mark is to be measured at a plurality of different focus positions, and based on the measurement position of the fiducial mark, the positional error information (offset amount) of the mark related to focus position is obtained. Accordingly, measurement results of the mark position at the best focus position can be obtained, even without preparing an auto-focus mechanism separately. Further, because the auto-focus mechanism will not be required, the size and the cost of alignment system AS can be reduced. Furthermore, because position measurement results at a plurality of different focus positions are used, the measurement accuracy of the positional information of the mark can be improved by an averaging effect.

However, it is a matter of course that a focus adjustment mechanism can be arranged in alignment system AS, and the positional information of the mark can be measured at a constant focus position (that is, the best focus position).

In the embodiment, the positional information of the reference mark or wafer mark M is detected at an arbitrary sampling interval, while the focus position is constantly changed. Accordingly, the mark will not have to be measured by setting the position of wafer W with respect to projection optical system PL when detecting the positional information of the reference mark or wafer mark M at a plurality of different focus positions, which allows the measurement time of the mark to be reduced.

However, it is a matter of course that wafer mark M or the fiducial mark can be measured while setting the position of wafer mark M or the fiducial mark at a plurality of focus positions, in a state where wafer stage WST is stationary.

To be more specific, based on the measurement position of the reference mark that has been obtained, a focus-position variation curve is to be made that shows the change of the measurement position of the reference mark with respect to the change of focus position. Then, the value of the variation curve of the reference mark at the extremum of the variation curve of the position is obtained as the offset amount, and based on the image sample data of the intensity image at the focus position that corresponds to the extremum, the positional information of the reference mark is detected.

Further, in the embodiment, an amplitude variation curve is also made that shows the change in amplitude of the spatial frequency component of each odd order with respect to the change of the focus position, and the positional shift amount of the reference mark based on the intensity data at the focus position, which is the extremum of the amplitude variation curve, is obtained as the offset amount. Accordingly, the best focus position of each order can be detected easily with the extremum of the amplitude variation curve as a hint, even if it is difficult to detect the extremum in the variation curve of the focus-mark position.

Further, according to the embodiment, the offset amount is obtained for each order of the spatial frequency included in the intensity mage of the reference mark, and positional information of the reference mark is detected for each order, and on the detection the offset amount according to the order is reflected in the measurement position of the mark.

Further, according to the embodiment, the measurement position of the mark is to be the weighted average value (including the case when the weight is zero) of the mark measurement positions detected per each order. Accordingly, based on the measurement position of the mark in a stable order, it becomes possible to obtain the position accurately.

Further, according to the embodiment, the reference mark is positioned at a predetermined reference position within the field of the light condensing optical system of alignment system AS, such as for example, the field center of the light condensing optical system, and based on the positional shift amount from the measurement position of the reference mark that has been positioned, the offset amount is obtained. Accordingly, the influence of the aberration of the light condensing optical system to the mark measurement position can be reduced, based on the actual measurement results.

However, the position does not have to be the field center of the light condensing optical system of the alignment system AS, as long as it is at a specific position within the field. For example, in the case wafer mark M is positioned within the field of alignment system AS, based on the baseline and the design position coordinate of wafer mark M, wafer mark M will be positioned at the position of the reference mark when the reference mark was measured, therefore, in this case, the position of the reference mark within the field will be the reference position. Accordingly, the reference mark and wafer mark M will be measured under the same aberration state, therefore, the influence of the aberration of the light condensing optical system to the mark position can be reduced.

However, by deformation of wafer W caused by the process, the position of the reference mark within the field of alignment AS and the position of the wafer mark may differ. In such a case, baseline measurement is performed at a plurality of points within the field using a plurality of design baselines so that a function of the baseline is made with X, Y within the field serving as an independent variable, and the value of the function when the XY position of wafer mark M within the field is substituted into the function can be used as the baseline.

Baseline measurement in a plurality of alignment systems can be performed with the interferometer as a reference, using a single reference mark, or the baseline measurement can be performed collectively, using a large fiducial mark so that baseline measurement of a plurality of alignment systems can be performed simultaneously. In the case of using a large fiducial mark, in order to deal with various shot sizes, a fiducial mark on which a two-dimensional or one-dimensional grating mark is formed all over can be employed. In this case, a vernier mark can be arranged so that measurement can be performed also with rough accuracy.

Further, according to the embodiment, the mark position is measured, based on the intensity image data at the focus position of which the offset amount is obtained. More specifically, the offset amount corresponding to a focus position, which is not the best focus position but a position on which position measurement has been performed, can be obtained from a variation curve, and the offset amount can be reflected in the measurement position.

Further, according to the embodiment, wafer mark M formed on wafer W is a mark that weakens the intensity of light of even order diffraction rather than the intensity of light of odd order diffraction, which is a reflection light of the illumination light from light source 42. Therefore, the spatial frequency component of the odd order of the spatial intensity image of wafer mark M can be detected with good accuracy. As a consequence, measurement errors on the positional information of wafer mark M are reduced.

Further, according to the embodiment, the periodic structure of wafer mark M includes a spatial frequency component whose fundamental period is period P and a spatial frequency component whose fundamental period is 2nP, which is an even multiple of period P. Accordingly, in the case the ratio of the period of two different fundamental frequency components included in the sectional shape of wafer mark M is to be an even number ratio, then it becomes possible to reduce the intensity of a low even order harmonic component, such as the 2^{nd} order.

Especially in the periodic structure of wafer mark M in the embodiment, a periodic uneven pattern whose fundamental period is period P and the total length in the periodic direction is nP is arranged distanced at period 2nP, and a width W in the periodic direction of the recessed section of the uneven pattern is set so that the width is less than half the period P. If such a structure is employed, then in the optical image of wafer mark M, two fundamental frequency components that reciprocally have an even number ratio relation will be included for certain. Further, as long as width W in the periodic direction of the recessed section is shorter than half the period P, then the mark position, which is measured, will not be influenced by the width of the recessed section. Accordingly, the degree of freedom increases in design of wafer mark M. As a consequence, the pitch of the mark can be made narrower, which makes it possible to perform alignment with high precision.

Further, according to the embodiment, in alignment system AS, the sum (NAi+NA) of numerical aperture NAi of the illumination optical system that illuminates a predetermined illumination light to wafer mark M and numerical aperture NA of the light condensing optical system that guides the illumination light that has passed through wafer mark M and forms the intensity image of wafer mark M is set, so that the sum becomes smaller than the value of wavelength λ₀, which is the shortest wavelength of the illumination light, divided by period P. More specifically, of the light having the shortest wavelength λ₀ to λ₁ of the illumination light, all lights of high even order diffraction will not be incident on the light condensing optical system of alignment system AL, therefore, light of high even order diffraction will completely avoid entering the light condensing optical system.

Further, alignment system AS related to the embodiment is equipped with the illumination optical system that illuminates a broadband illumination light on the wafer mark, the light condensing optical system (the first objective lens 48 and the second objective lens 58) that guides the illumination light that has passed through wafer mark M and forms the intensity image of wafer mark M, imaging device 60 that photoelectrically detects the intensity image, and image processing system 62 that performs Fourier transform on the signals corresponding to the intensity image that has been detected and measures the positional information of wafer mark M based on the odd order harmonic component of the Fourier spectrum of the signals. That is, because the mark position of wafer mark M is measured, using a broadband illumination light and also based on the odd order harmonic component that has a large amplitude, it becomes possible to measure the mark position with good accuracy in a state where the S/N ratio is high, regardless of film interference.

Further, in the embodiment, image processing system 62 corrects the positional information of wafer mark M, based on the positional shift data of the intensity image of wafer mark M due to chromatic aberration of the light condensing optical system (the first objective lens 48 and the second objective lens 58) of alignment system AS, therefore, the mark position can be measured with good accuracy, regardless of the chromatic aberration of the light condensing optical system of alignment system AS.

In this case, in the embodiment, on correcting the positional information of wafer mark M, image processing system 62 uses the positional shift data of the mark image of different chromatic aberrations according to the order of the odd order harmonic component used for measuring the positional information of wafer mark M. Because the position through which the diffracted lights of each order passes within the pupil plane of the light condensing optical system (the first objective lens 48 and the second objective lens 58) is different, the chromatic aberration has to be obtained for each order.

In order to achieve this chromatic aberration correction, alignment system AS is further equipped with spectrometer 59 that measures the spectral reflectivity characteristics of wafer mark M. Based on the spectral reflectivity characteristics of wafer mark M measured by spectrometer 59 to the wavelength of the illumination light, image processing system 62 computes the mark position shift data related to the chromatic aberration of the light condensing optical system of alignment system AS. Then, based on the mark position shift data related to the chromatic aberration of the light condensing optical system that has been computed, image processing system 62 corrects the measurement position of wafer mark M. Accordingly, an accurate correction of chromatic aberration becomes possible, based on the spectral reflectivity characteristics that have been actually measured.

Further, alignment system AS is further equipped with color filter 50 that can adjust the wavelength of the diffracted light that contributes to forming the intensity image of wafer mark M. Color filter 50 is used when obtaining the relation between the spectral reflectivity characteristics of wafer mark M in spectrometer 59 and the positional shift of the intensity image of wafer mark M. Accordingly, by using color filter 50, the relation between the wavelength of the illumination light and the lateral shift of the mark, or in other words, the positional shift due to chromatic aberration, can be obtained with good precision.

Further, according to the embodiment, of the diffracted light from wafer mark M, alignment system AS guides the zero order light and the light of odd order diffraction so as to form the intensity image of wafer mark M, photoelectrically detects the intensity image, and performs Fourier transform on the image signals that correspond to the intensity image that has been detected. And then, based on the odd order harmonic component of the Fourier spectrum, alignment system AS measures the position of wafer mark M. Accordingly, the beat of the light of even order diffraction and the light of odd order diffraction will not be included as the odd order spatial frequency component in the mark image, therefore, the mark position can be measured with good accuracy.

In alignment system AS related to the embodiment above, interference signals are not extracted at the pupil conjugate position of the light condensing optical system as in the alignment sensor disclosed in, for example, the pamphlet of International Publication No. WO98/39689, and Fourier transform is performed on the image of wafer mark M that has been achromatized in the space of the mark image. Accordingly, in alignment system AS related to the embodiment above, a light source that has a broadband wavelength range can be used, and the mark position can be measured with good accuracy, regardless of the generation of optical noise such as a spectrum.

Wafer mark M in the embodiment above can be modified in various ways. In the description below, several modified examples will be described.

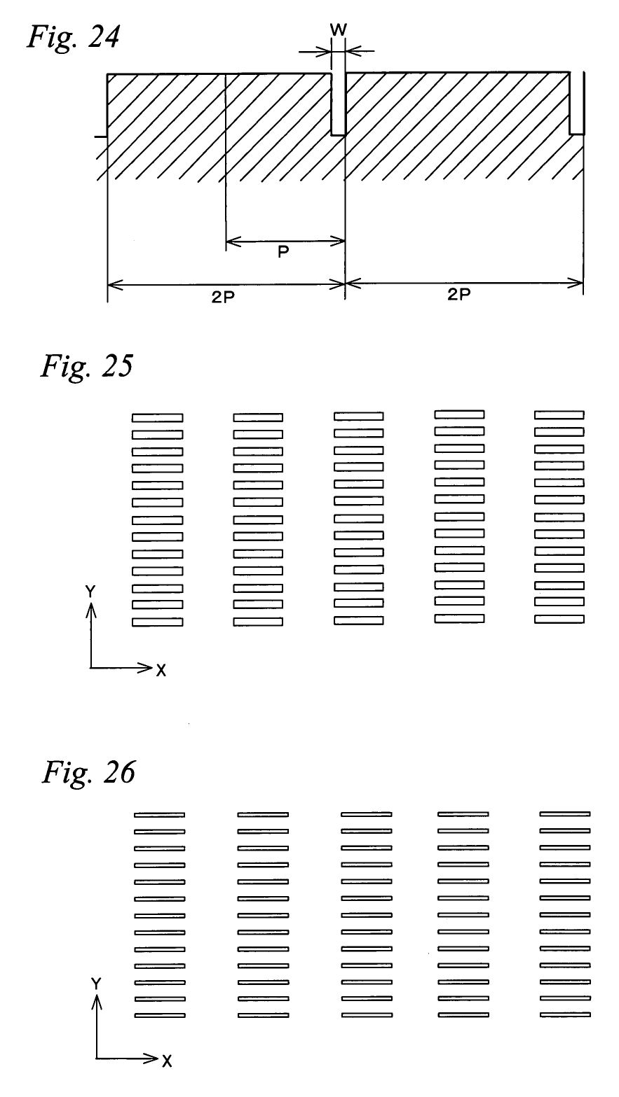

For example, narrow groove marks as is shown in FIG. 24 can be employed. This mark contains one narrow groove within one period. The fundamental frequency of this mark is 2P. From this mark, in addition to the zero order light and the light of odd order diffraction, ±2^{nd} order diffracted lights are also generated, however, because the relation between the sum (NAi+NA) of numerical aperture NAi of the illumination optical system and numerical aperture NA of the light condensing optical system, wavelength λ₀, which is the shortest wavelength of the illumination light, and fundamental period P will be the same as in the embodiment above, the ±2^{nd} order diffracted lights are not incident on the light condensing optical system of alignment system AS. As a consequence, the diffracted light that contributes to spatial intensity image of wafer mark M formed on imaging device 60 is limited only to the zero order light and the lights of the ±1^{st} order, and as in the embodiment above, it becomes possible to detect the mark position form the fundamental frequency component of the intensity image by the zero order light and the lights of the ±1^{st} order.

FIG. 25 shows an example of a mark that has been narrowed while the duty of the mark remains 1:1, which is different from the mark described above. FIG. 25 is a view when viewed from above, and the measurement direction is the X-axis direction. In FIG. 25, the recessed section (groove section) of the mark is indicated in gray. In this mark, the duty ratio of the bright section and the dark section in the measurement direction is 1:1. Further, in this mark, an uneven pattern is formed also in the non-measurement direction (the direction orthogonal to the measurement direction, in this case, the Y-axis direction) in the recessed section. Further, the duty ratio of the uneven pattern in the non-measurement direction is 1:1. In the measurement direction, because the duty ratio of the mark is maintained at 1:1, the diffracted light generated from the mark will only be the light of odd order diffraction, and similar to the embodiment above, the mark position can be measured with good accuracy using the spatial frequency component of the odd order. Further, because the mark is narrowed in the non-measurement direction, the mark takes on a structure strong to deformation in the CMP process, and the symmetry of the mark in the measurement direction is maintained. And, by employing such a mark, the mark position can be measured with high precision.

FIG. 26 further shows another modified example of the mark. This mark has a narrower groove in the recessed section in the non-measurement direction than the mark shown in FIG. 26. If this mark is employed, mark deformation in the CMP process can be suppressed further, and the symmetry of the mark can be maintained.

In the mark whose symmetry is maintained in the manner described above, because the mark image of the wafer surface from the best focus position of alignment system AS will not shift laterally due to defocus, errors of the mark detection position due to defocus can be reduced.

Further, in the embodiment, since σ≧1 is set, the depth of the recessed section can be of any depth. Accordingly, the degree of freedom increases in design of the mark. Further, wafer mark M was a mark whose recessed section is narrow compared to the projected section, however, the mark can be a mark whose projected section is narrow compared to the recessed section.

Incidentally, the arrangement position of filter 50 can be a position between the half mirror and the condenser lens. In the case the chromatic aberration is small enough to be ignored, the apparatus does not have to be equipped with color filter 50 and spectrometer 59. As is described above, various modifications can be applied to the configuration of alignment system AS. Further, the illumination light of alignment system AS can be of any wavelength as long as it is a wavelength that does not expose the resist, and it is a matter of course that the illumination light can be a lamp other than the halogen lamp. Furthermore, a plurality of light sources that emit illumination light of a single wavelength can be used so as to form an illumination light that has a broadband spectral span.

In the embodiment above, the mark having an uneven pattern was described, however, the mark can also be a contrast mark whose arrangement of the bright section and the dark section is the same as the projected section and the recessed section in the embodiment above. Besides such marks, as the mark, a mark that generates a finite harmonic can also be employed. For example, a mark that has a sinusoidal amplitude distribution, a mark that has a sinusoidal phase distribution, and a mark that has an exponential amplitude distribution can be employed.

The mark can be a mark having a 1:1 duty ratio. This is because such a mark also generates only the zero order light and the light of odd order diffraction. However, when the mark is a step mark that has a duty ratio of 1:1 and a constant reflectivity, in the case σ≧1 is set, the intensity of the zero order light is weakened as a whole and the intensity image contrast of the mark may decrease significantly. From this standpoint, because the narrow groove mark like the one described in the embodiment above has a different duty ratio, the zero order light does not disappear, and it becomes possible to detect the intensity image of the mark with high contrast.

Further, in the embodiment, alignment system AS employed illumination light that has a predetermined wavelength band (λ₀ to λ₁), however, the present invention can also be suitably applied to an alignment system that can selectively choose light having a wavelength of the best measurement accuracy according to the wafer mark. That is, the mark position is to be corrected, using the chromatic aberration amount according to the wavelength that has been selected.

For example, in the case the intensity of the zero order light from the mark is small, the wavelength of the diffracted light is to be changed prior to the measurement, so that the intensity of the zero order light will become larger, and the wavelength of the diffracted light that contributes to the imaging of the intensity image is adjusted. When the zero order light becomes strong, the contrast of the intensity of the image on the imaging plane of imaging device 60 becomes large, which makes it possible to measure the mark position with high precision. The usage of such color filter 50 is not limited to the alignment system that uses broadband illumination light.

Further, the mark can be a mark that generates light of even order diffraction. In this case, the alignment system can be equipped with a spatial filter that removes the light of even order diffraction.

Incidentally, reticle alignment marks on reticle R can also be the same narrow groove mark as the mark related to the embodiment described above, and the present invention can be applied.

Further, the embodiment can also be viewed as a measurement method in which the coherent factor equals 1 or more, and the mark that is to be measured is to be a so-called narrow groove mark.

Further, there may be a case when the angle between the wafer surface and the optical axis of alignment system AS is not perpendicular due to the unevenness of the wafer surface or an error in the optical adjustment of the alignment system. When the maximum angle of such an error is expressed as θ, by satisfying σ>2 sin θ+1, vignetting of the reflected light caused by the oblique angle of the optical axis of alignment system AS can be avoided.

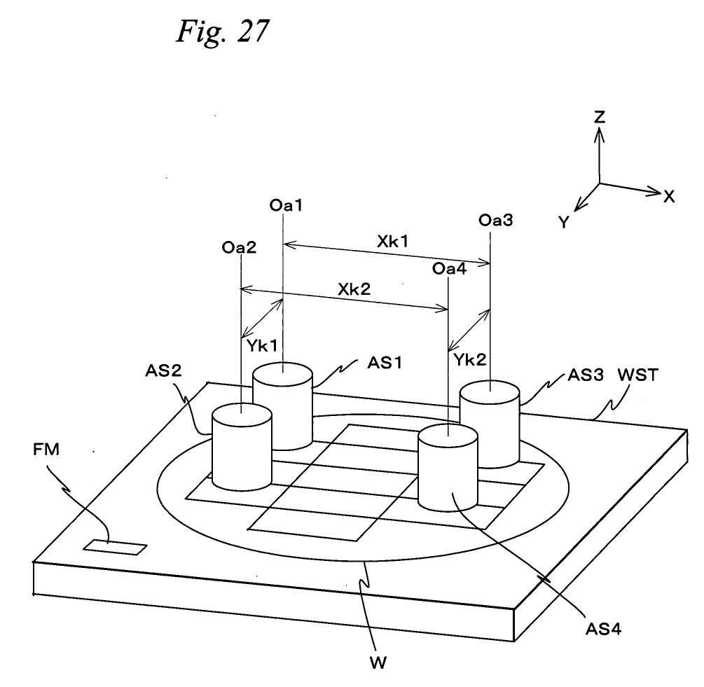

Further, in the embodiment, exposure apparatus 100 is equipped with one alignment system. However, exposure apparatus 100 can be equipped with a plurality of alignment systems. FIG. 27 shows an arrangement example of four alignment systems. Alignment systems AS1 to AS4 individually have the same configuration as alignment system AS shown in FIG. 2A. Alignment systems AS1 to AS4 are each finely drivable within the XY plane by a drive unit (not shown), and the position of optical axes Oa1, Oa2, Oa3, and Oa4 of each of the alignment systems can be set at an arbitrary XY position within a predetermined range. Accordingly, it becomes possible to set relative distances Xk1, Xk2, Yk1, and Yk2 of optical axes Oa1, Oa2, Oa3, and Oa4 to an integral multiple of the shot distance in the X-axis and Y-axis directions, which makes it possible to pick up four wafer marks simultaneously within each individual field of the four alignment systems AS.

In the case the field is Φ500 to 1000 [μm], a known mechanical mechanism, such as for example, a cam mechanism will be sufficient enough for the mechanism used for driving each alignment.

From the viewpoint of throughput, it is preferable to simultaneously detect the four wafer marks M formed according to a shot arrangement on wafer W using the four alignment systems AS1 to AS4. However, it is physically difficult to simultaneously measure the mark position at the best focus positions at four measurement points. Therefore, in the case of using four alignment systems as well, mark measurement is to be performed while moving the wafer stage in the focus direction as in the embodiment. Accordingly, at the four measurement points, focusing to the best focus position will not have to be performed separately at each measurement point, which make it possible to simultaneously measure the marks with high precision at the four measurement points. Incidentally, prior to fine alignment, mark measurement can be performed in advance using the four alignment systems AS1 to AS4, while moving the wafer stage in the focus direction. Then, by obtaining the amplitude variation curve for each alignment system in advance, measurement of the mark position can be performed simultaneously at the four measurement points. For example, at the focus position, which is to be the extremum of the amplitude variation curve for alignment system AS1 on fine alignment, the marks are simultaneously measured at the four measurement points using the four alignment systems AS1 to AS4. For alignment system AS1, the value of the position variation curve of the reference mark at the extremum of the amplitude variation curve at the focus position is obtained as the offset amount. As for the other alignment systems AS2 to AS4, the offset amount is assumed from each of the amplitude variation curves, with the offset amount at the focus position, which is the extremum of the amplitude variation curve for alignment system AS1. Accordingly, it becomes possible to perform measurement of the mark position simultaneously at the four measurement points, even if the marks are not measured while moving the wafer stage in the focus direction on fine alignment.

Further, in the embodiment, the reference mark for measuring the baseline uses a mark with the same design as wafer mark M. Therefore, in the case σ≧1 is set, as long as the aberration does not change temporally, the variation curve of the mark measurement position will not change according to the step, reflectivity and the like of the mark, and baseline measurement can be performed with high precision. The baseline measurement amount in this case also is obtained per each order.

Further, in the embodiment above, the intensity image of the mark that has been detected was decomposed into the spatial frequency component of the odd order, and mark position measurement was performed for each order of the spatial frequency component. However, the mark position can also be measured detecting the edge in photoelectrical signals that correspond to the mark intensity image, and using an edge detection method or an autocorrelation method in order to detect the mark position from the edge position. Even in such a case, when σ≧1 is set, the change in positional shift of the intensity image of the mark to focus will not be affected by the step amount of the mark, which improves the measurement accuracy of the mark position.

In the embodiment above, alignment system AS was a detection system by the epi-illumination method, however alignment system AS can also be a detection system by the transmission-illumination method.

Further, in the embodiment above, global alignment by the EGA method or the like was employed as the alignment method, however, it is also a matter of course that the die-by-die method can be employed.

Further, in the embodiment, the case has been described where the KrF excimer laser beam (248 nm) or the ArF excimer laser beam (193 nm) was used as the exposure light. The present invention is not limited to this, and the g-line (436 nm), the i-line (365 nm), the F₂ laser beam (wavelength 157 nm), the Ar₂ excimer laser (126 nm), harmonic such as the copper vapor laser, the YAG laser, the semiconductor laser or the like can also be used as the illumination light for exposure. As the exposure light, as is disclosed in, for example, the pamphlet of International Publication No. WO99/46835, a harmonic wave may also be used that is obtained by amplifying a single-wavelength laser beam in the infrared or visible range emitted by a DFB semiconductor laser or fiber laser, with a fiber amplifier doped with, for example, erbium (or both erbium and ytteribium), and by converting the wavelength into ultraviolet light using a nonlinear optical crystal.

Further, in exposure apparatus 100 of the embodiment above, as projection optical system PL a reduction system, a system of equal magnification, or a magnifying system can be used, and the system can also be a refracting system, a catodioptric system, or a reflection system. Projection optical system PL, which is made up of a plurality of lenses, is incorporated into the main body of the exposure apparatus. Then, by performing optical adjustment, as well as attaching the reticle stage and wafer stage built from many mechanical parts to the main body of the exposure apparatus, connecting the wiring and piping, and furthermore, performing total adjustment (such as electric adjustment and operation adjustment), the exposure apparatus in the embodiment above can be made. The making of the exposure apparatus is preferably performed in a clean room where temperature, the degree of cleanliness and the like are controlled.

In the embodiment above, the case has been described where the present invention is applied to a projection exposure apparatus by the step-and-scan method. However, the present invention is not limited to this, and the present invention can also be applied to other types of exposure apparatus such as a projection exposure apparatus by the step-and-repeat method, an exposure apparatus by the proximity method or the like. Further, the present invention can also be suitably applied to a reduction projection exposure apparatus by the step-and-stitch method in which a shot area and a shot area are merged. Furthermore, the present invention can also be applied to a twin stage type exposure apparatus, which is equipped with two wafer stages as is disclosed in, for example, the pamphlet of International Publication No. WO98/24115 and the pamphlet of International Publication No. WO98/40791. Further, for example, the present invention can also be applied to an exposure apparatus that employs a liquid immersion method as is disclosed in, for example, the pamphlet of International Publication No. WO99/49504.

Further, the present invention is not limited to the exposure apparatus for manufacturing semiconductors, and it can also be widely applied to an exposure apparatus for manufacturing displays including a liquid crystal display device that transfers a device pattern on a glass plate, an exposure apparatus that transfers a device pattern used for manufacturing thin film magnetic heads onto a ceramic wafer, or to an exposure apparatus used for manufacturing imaging devices (such as CCDs), micromachines, organic ELs, DNA chips and the like. Further, the present invention can also be applied to an exposure apparatus that uses an EUV light (oscillation spectrum 5 to 15 nm (soft X-ray region)), an X-ray, an electron beam that uses Lanthanum Boride (LaB₆) and Tantalum (Ta) of a thermal electron emission type as the electron gun, or a charged particle beam such as an ion beam as the exposure beam.

In the embodiment above, a transmittance type mask, which is a transmissive substrate on which a predetermined light shielding pattern (or a phase pattern or a light attenuation pattern) is formed, or a reflection type mask, which is a light reflective substrate on which a predetermined reflection pattern is formed on, was used. Instead of this mask, however, an electron mask on which a light-transmitting pattern, a reflection pattern, or an emission pattern is formed according to electronic data of the pattern that is to be exposed can also be used. Details on such an electron mask are disclosed in, for example, U.S. Pat. No. 6,778,257 description.

The electron mask described above is a concept that includes both a non-emissive image display device and a self-emissive image display device. In this case, the non-emissive image display device is also called a spatial light modulator, and is a device that spatially modulates amplitude, phase or the state of polarization, and can be divided into a transmissive spatial light modulator and a reflective spatial light modulator. Transmissive spatial light modulators include a transmissive liquid crystal display device (LCD: Liquid Crystal Display), an electrochromic display (ECD) and the like. Further, reflective spatial light modulators include a DMD (Digital Mirror Device, or Digital Micro-mirror Device), a reflection mirror array, a reflective liquid crystal display device, an electrophoreitc display (EPD: ElectroPhoretic Display), an electron paper (or an electron ink), a grating light valve (Grating Light Valve) and the like.

Further, self-emissive display image display devices include a CRT (Cathode Ray Tube), an inorganic EL (Electro Luminescence) display, a field emission display (FED), a plasma display (PDP: Plasma Display Panel), a solid light source chip having a plurality of light-emitting points, a solid light source chip array where a plurality of chips are arranged in an array shape, a solid light source array (e.g., LED (Light Emitting Diode) display, an OLED (Organic Light Emitting Diode) display, an LD (Laser Diode) display and the like) in which a plurality of light-emitting points are made into a substrate and the like. Incidentally, when the fluorescent substance arranged in each pixel of the known plasma display (PDP) is removed, the device becomes a self-emissive image display device that emits light in the ultraviolet region.

Further, the present invention can also be applied to an exposure apparatus that transfers a circuit pattern onto a glass substrate or a silicon wafer not only when producing microdevices such as semiconductors, but also when producing a reticle or a mask used in exposure apparatus such as an optical exposure apparatus, an EUV exposure apparatus, an X-ray exposure apparatus, or an electron beam exposure apparatus. Normally, in the exposure apparatus that uses DUV (deep (far) ultraviolet) light or VUV (vacuum ultraviolet) light, a transmittance type reticle is used, and as the reticle substrate, materials such as silica glass, fluorine-doped silica glass, fluorite, magnesium fluoride, or crystal are used. Further, in the exposure apparatus by the proximity method or the electron beam exposure apparatus, a transmittance type mask (a stencil mask, a membrane mask) is used, and as the mask substrate, a silicon wafer or the like is used.

Further, in the embodiment above, the exposure light of the exposure apparatus is not limited the light having the wavelength equal to or greater than 100 nm, and it is needless to say that the light having the wavelength less than 100 nm may be used. For example, in recent years, in order to expose a pattern equal to or less than 70 nm, an EUV exposure apparatus that makes an SOR or a plasma laser as a light source generate an EUV (Extreme Ultraviolet) light in a soft X-ray range (such as a wavelength range from 5 to 15 nm), and uses a total reflection reduction optical system designed under the exposure wavelength (such as 13.5 nm) and the reflective type mask has been developed. In such EUV exposure apparatus, the arrangement in which scanning exposure is performed by synchronously scanning a mask and a wafer using a circular arc illumination can be considered,

Further, the present invention can also be applied to an exposure apparatus that uses a charged particle beam such as an electron beam or an ion beam. Incidentally, the electron beam exposure apparatus can be an apparatus by any one of a pencil beam method, a variable-shaped beam method, a self-projection method, a blanking aperture array method, and a mask projection method. For example, in the exposure apparatus that uses the electron beam, an optical system equipped with an electromagnetic lens is to be used.

Further, the mark for position alignment is not a mark used only for alignment in the exposure apparatus, and it is possible to apply the present invention to a mark and an alignment system used for position alignment in a unit that requires position alignment of the wafer on measurement, such as, for example, an overlay measuring instrument used for measuring the overlay error of the shot areas on the wafer. Accordingly, if the measurement unit measures the alignment mark formed on the object or the positional information of the mark, the present invention can be applied.

Further, the pattern method of the present invention is not limited to exposure apparatus, and the present invention can be applied to a unit if the unit is equipped with the mark measurement unit of the present invention that measures the positional information of a mark formed on an object, and a controller that controls the position of the object when a pattern is formed based on the positional information measured by the mark measurement unit. For example, the present invention can be applied to a pattern forming unit similar to a device manufacturing unit whose details are disclosed in, for example, Kokai (Japanese Unexamined Patent Application Publication) No. 2004-130312, which is equipped with a functional liquid applying unit by an ink jet method similar to an ink jet head group. The ink jet head group disclosed in the publication above has a plurality of ink jet heads that discharges a predetermined functional liquid (a metal-containing liquid, a photosensitive material or the like) from a nozzle (discharge port) and applies the functional liquid to the substrate (e.g., PET, glass, silicon, paper and the like). Accordingly, the positional information of the mark formed on the substrate can be measured with the mark measurement unit, and based on the measurement results, the controller can control the relative position of the substrate with respect to the ink jet head group when the pattern is formed.

The above disclosures of the Kokai/Kohyo publications, the pamphlet of the International Publications, the U.S. patent application publications, and the U.S. patents are each incorporated herein by reference.

Microdevices are manufactured through the following steps: a step where the function/performance design of a device is performed; a step where a mask (reticle) based on the design step is manufactured; a substrate processing step; a device assembly step (including processes such as a dicing process, a bonding process, and a packaging process); an inspection step, and the like. In the substrate processing step, a step in which a pre-process necessary for the substrate (a wafer or a glass plate) is performed, a step in which a pattern of a mask (reticle) is transferred onto the substrate using the exposure apparatus or the like described in the embodiment above, a step in which the substrate that has bee exposed is developed, a step in which an exposed member of a section other than the section where the resist remains is removed by etching, a step in which the resist that is no longer necessary since etching is completed is removed and the like are repeatedly performed.

Further, of the exposure of a plurality of layers performed in the exposure apparatus described above, instead of exposure of at least one layer, a pattern can be formed on the substrate using the device manufacturing unit previously described. In this case as well, the pattern can be formed with high precision, therefore, as a consequence, it becomes possible to improve the productivity of the device (including yield).

While the above-described embodiments of the present invention are the presently preferred embodiments thereof, those skilled in the art of lithography systems will readily recognize that numerous additions, modifications, and substitutions may be made to the above-described embodiments without departing from the spirit and scope thereof. It is intended that all such modifications, additions, and substitutions fall within the scope of the present invention, which is best defined by the claims appended below.

What is claimed is:

1. A measurement method, the method comprising:
a detection process in which a detection unit that has
an illumination optical system that irradiates an illumination light on a period mark formed on an object,
a light condensing optical system that condenses only a zero order light and light of an odd order diffraction from the period mark irradiated by the illumination light, and
a photoelectric conversion unit that converts the light that has been condensed into an electrical signal, and
whose ratio of numerical aperture of the illumination optical system to the numerical aperture of the light condensing optical system is set to one or more
is used to detect positional information related to a periodic direction of the period mark.

2. The measurement method according to claim 1, the method further comprising:
an obtaining process in which positional error information related to a focus position of the period mark with respect to the light condensing optical system is obtained.

3. The measurement method according to claim 2 wherein in the detection process,
positional error information corresponding to a focus position when the measurement was performed is reflected in the positional information.

4. The measurement method according to claim 2 wherein the obtaining process comprises:
a first sub-process in which positional information of the period mark is obtained at each of the plurality of focus positions; and
a second sub-process in which positional error information of the period mark related to the focus position is obtained, based on detection results of the first sub-process.

5. The measurement method according to claim 4 wherein in the first sub-process,
positional information of the period mark is detected in an optional sampling interval while the focus position is constantly changed.

6. The measurement method according to claim 4 wherein in the second sub-process,
based on measurement results of the first sub-process, a position variation curve that shows a change in positional information of the period mark with respect to a change in the focus position is made by applying a polynomial approximation method of a 2^{nd} order or more to a positional shift data.

7. The measurement method according to claim 4 wherein in the obtaining process,
a positional shift amount of the period mark at an extremum of the position variation curve or an averaged value of all positional shift data within a predetermined focus range around the extremum is obtained as the positional error information, and
in the detection process,
positional information of the period mark is detected, based on a peak value in an approximation curve at a focus position corresponding to the extremum or an averaged positional shift amount within a predetermined focus range close to the extremum.

8. The measurement method according to claim 4 wherein in the second sub-process,
an amplitude variation curve that shows a change in amplitude with respect to a change in the focus position is made, and a positional shift amount of the period mark based on the electrical signal at the focus position, which is an extremum of the amplitude variation curve, is obtained as the positional error information, and
in the detection process,
positional information of the period mark is detected based on a peak value in an approximation curve at a focus position corresponding to the extremum or an averaged positional shift amount within a predetermined focus range close to the extremum.

9. The measurement method according to claim 2 wherein in the obtaining process,
the positional error information is obtained for each order of a spatial frequency included in an intensity image of the period mark.

10. The measurement method according to claim 9 wherein in the detection process,
positional information of the period mark is detected for each order, and on detection, the positional error information according to the order is reflected in the measurement results.

11. The measurement method according to claim 9 wherein in the detection process,
positional information of the period mark is to be a weighted average of positional information of the period mark detected for each order.

12. The measurement method according to claim 2 wherein in the obtaining process,
the period mark is positioned at a predetermined reference position within a field of the light condensing optical system, and based on a positional shift amount of positional information in the periodic direction of the positioned period mark from the reference position, the positional error information is obtained.

13. The measurement method according to claim 12 wherein
the reference position is a center of field of the light condensing optical system.

14. The measurement method according to claim 12 wherein in the detection process,
positional information of the period mark is detected, based on the photoelectrical signal at the focus position where the positional error information was obtained in the obtaining process.

15. The measurement method according to claim 12 wherein in the obtaining process,
the positional error information is obtained at a plurality of different focus positions.

16. The measurement method according to claim 15 wherein in the detection process,
positional error information corresponding to a focus position when detection of the positional information was performed is reflected in the positional information.

17. The measurement method according to claim 1 wherein as the period mark,
a mark in which light of an even order diffraction under a predetermined order is weakened of diffracted lights generated by the incoming illumination light is used.

18. The measurement method according to claim 17 wherein
the period mark includes
a first component that uses a first period as a fundamental frequency and a second component that uses a second period, which is an even multiple of the first period, as a fundamental frequency.

19. The measurement method according to claim 18 wherein
the period mark has
a periodical uneven pattern arranged at the second period that uses the first period as the fundamental frequency and whose total length in the periodic direction is half the second period, and
a width in the periodic direction of a recessed section of the uneven pattern is set shorter than half the first period.

20. The measurement method according to claim 19 wherein
a sum of a numerical aperture of the illumination optical system and a numerical aperture of the light condensing optical system is set so that the sum becomes smaller than a value of a wavelength of the illumination light divided by the shortest period of the fundamental frequency of the period mark.

21. The measurement method according to claim 17 wherein
the illumination light is a light that has a predetermined wavelength band, and
prior to the obtaining process, the method further comprises:
a wavelength selection process in which a wavelength that does not obliterate the zero order light from the period mark is selected as a wavelength of the illumination light that illuminates the period mark.

22. A measurement unit that measures positional information of an alignment mark formed on an object subject to processing, using the measurement method according to claim 1.

23. A processing unit, comprising:
the measurement unit according to claim 22; and
a position controller that controls a position of the object based on measurement results of the measurement unit.

24. A pattern forming method in which a pattern is formed on an object, the method comprising:
a measurement process in which positional information of alignment marks formed on the object is measured using the measurement method according to claim 1; and
a control process in which a position of the object when the pattern is formed is controlled, based on measurement results of the positional information.

25. The pattern forming method according to claim 24 wherein
formation of the pattern onto the object is performed by exposing the object with an energy beam.

26. A device manufacturing method, comprising:
a process in which a pattern is formed on an object using the pattern forming method according to claim 24; and
a process in which processing is applied to the object on which the pattern is formed.

27. A measurement method, comprising:
a detection process in which a detection unit that has
an illumination optical system that irradiates an illumination light on a period mark formed on an object,
a light condensing optical system that condenses diffracted light from the mark, and
a photoelectric conversion unit that converts the light that has been condensed into an electrical signal, and
whose ratio of numerical aperture of the illumination optical system to the numerical aperture of the light condensing optical system is set to one or more
is used to detect positional information related to a periodic direction of the period mark that includes a first component using a first period as a fundamental frequency and a second component using a second period, which is an even multiple of the first period, as a fundamental frequency.

28. The measurement method according to claim 27 wherein
the structure of the period mark is
a structure in which the first period is a fundamental frequency and a periodical uneven pattern whose total length in the periodic direction is half the second period is arranged at the second period, and
a width in the periodic direction of a recessed section of the uneven pattern is set shorter than half the first period.

29. The measurement method according to claim 28 wherein
a sum of a numerical aperture of the illumination optical system and a numerical aperture of the light condensing optical system is to be set so that the sum is smaller than a value of a wavelength of the illumination light divided by the shortest period of the fundamental frequency of the period mark.

30. A measurement unit that measures positional information of an alignment mark formed on an object subject to processing, using the measurement method according to claim 27.

31. A processing unit, comprising:
the measurement unit according to claim 30; and
a position controller that controls a position of the object based on measurement results of the measurement unit.

32. A pattern forming method in which a pattern is formed on an object, the method comprising:
a measurement process in which positional information of alignment marks formed on the object is measured using the measurement method according to claim 27; and
a control process in which a position of the object when the pattern is formed is controlled, based on measurement results of the positional information.

33. The pattern forming method according to claim 32 wherein
formation of the pattern onto the object is performed by exposing the object with an energy beam.

34. A device manufacturing method, comprising:
a process in which a pattern is formed on an object using the pattern forming method according to claim 32; and
a process in which processing is applied to the object on which the pattern is formed.

35. A measurement method in which a plurality of detection units that is arranged so that each of a plurality of marks arranged on a plurality of different places on an object are simultaneously measurable is used to detect positional information of the marks, the detection units each having
an illumination optical system that irradiates illumination light on a mark formed on the object,
a light condensing optical system that condenses diffracted light from the mark; and
a photoelectric conversion unit that converts the light that has been condensed into an electrical signal, whereby
positional information of the mark is measured at an arbitrary sampling interval using the detection unit, while the focus position of the mark to the light condensing optical system is changed in a predetermined range.

36. A measurement unit that measures positional information of an alignment mark formed on an object subject to processing, using the measurement method according to claim 35.

37. A processing unit, comprising:
a measurement unit according to claim 36; and
a position controller that controls a position of the object, based on measurement results of the measurement unit.

38. A pattern forming method in which a pattern is formed on an object, the method comprising:
a measurement process in which positional information of alignment marks formed on the object is measured using the measurement method according to claim 35; and
a control process in which a position of the object when the pattern is formed is controlled, based on measurement results of the positional information.

39. The pattern forming method according to claim 38 wherein
formation of the pattern onto the object is performed by exposing the object with an energy beam.

40. A device manufacturing method, comprising:
a process in which a pattern is formed on an object using the pattern forming method according to claim 38; and
a process in which processing is applied to the object on which the pattern is formed.

41. A measurement unit, comprising:
an illumination optical system that irradiates an illumination light on a period mark formed on an object;
a light condensing optical system that condenses only zero order light and light of an odd order diffraction from the period mark due to irradiation of the illumination light;
a photoelectric conversion unit that converts the condensed light into an electrical signal; and
a computation unit that computes positional information related to periodic direction of the period mark based on the electrical signal, whereby
ratio of numerical aperture of the illumination optical system to the numerical aperture of the light condensing optical system is set to one or more.

42. A processing unit, comprising:
a measurement unit according to claim 41; and
a position controller that controls a position of the object, based on measurement results of the measurement unit.

43. A measurement unit, comprising:
a plurality of detection units that each have
an illumination optical system that irradiates an illumination light on a mark formed on an object,
a light condensing optical system that condenses diffracted light from the mark, and
a photoelectric conversion unit that converts the condensed light into an electrical signal, and
is arranged so that each of a plurality of marks arranged on a plurality of different places on the object are simultaneously measurable; and
a controller that measures positional information of the plurality of marks at an arbitrary sampling interval using the plurality of detection units, while the position of the object in an optical axis direction of the light condensing optical system is changed in a predetermined range.

44. A processing unit, comprising:
a measurement unit according to claim 43; and
a position controller that controls a position of the object, based on measurement results of the measurement unit.
